(19) United States
(12) Patent Application Publication
(10) Pub. No.: US 2026/0257221 A1
(43) Pub. Date: Sep. 3, 2026

(54) FLUIDICS, MICROPLATE, AND METHOD INCLUDING INTEGRATED RESISTIVE HEATING

(71) Applicant: PLENO, INC., San Diego, CA (US)

(72) Inventors: Paul Anderson, San Diego, CA (US); Ludovic Vincent, San Diego, CA (US)

(21) Appl. No.: 19/655,469

(22) Filed: Apr. 22, 2026

Related U.S. Application Data
(63) Continuation of application No. PCT/US2024/052400, filed on Oct. 22, 2024.
(60) Provisional application No. 63/592,314, filed on Oct. 23, 2023.

(51) Int. Cl. B01L 3/00

(52) U.S. Cl. CPC B01L 3/502715; B01L 2300/0663; B01L 2300/0829; B01L 2300/0864; B01L 2300/12; B01L 2300/168; B01L 2300/1827

(57) ABSTRACT

The subject matter of the present disclosures relates generally to the processing of biological materials and more particularly to a fluidics system, microplate, and method including integrated resistive heating.

### CROSS-REFERENCE

The present application is a Continuation Application of PCT/US/2024/052400, filed on Oct. 22, 2024, which claims the benefit of U.S. Provisional Application Ser. No. 63/592,314, filed on Oct. 23, 2023, each of which is herein incorporated by reference in its entirety.

### BACKGROUND

Microfluidics (or fluidics) systems and devices are used in a variety of applications to manipulate, process and/or analyze biological materials. For example, microplates and liquid handling systems can be used to manipulate, process, and/or analyze biological materials.

Microplates may include multiple wells in which biological materials may be processed. Accordingly, chemical reactions or assays may be performed in each well. The chemistry may be performed at a certain temperature or within a certain temperature range. For example, polymerase chain reaction (PCR) is a laboratory technique for rapidly producing many copies of a segment of deoxyribonucleic acid (DNA), which can be studied in detail. PCR includes temperature cycling between, for example, from about 20° C. to about 95° C.

A microfluidics (or fluidics) instrument is used to hold the multi-well microplate and the multiple wells comprise the chemistry for processing biological materials. With respect to maintaining a processing temperature, the entire instrument environment may be heated (e.g., hot air system) when in use. The heated environment may be detrimental to other subsystems of the instrument (outside of the chemistry), such as to any mechanical subsystems, the optical detection system, and the like. Further, with respect to cycling the operating temperature, thermocouples in or near the wells may be used as a feedback mechanism. However, a hot air system with thermocouples may have a delayed response time, which may add to the processing time. Other methods of heating are possible, such as a Peltier system in direct contact with the microplate. However, the presence of the Peltier system in direct contact with the microplate can pose a line-of-sight obstacle with respect to the optical detection system.

### SUMMARY

Aspects disclosed herein provide microplates used for heating a sample, the microplate comprising: (a) a well structure comprising at least one well configured to support the sample; and (b) a heater integrated into the microplate, wherein the heater integrated into the microplate is configured to provide localized resistive heat to the well structure by heating both the well structure and the sample, wherein the localized resistive heat does not substantially heat a surrounding environment of the microplate. In some embodiments, the heater comprises a substrate and a resistive heating layer patterned thereon. In some embodiments, the pattern of the resistive heating layer comprises at least one opening that substantially matches the configuration of the at least one well. In some embodiments, the pattern of the resistive heating layer is configured to allow the heater to provide localized resistive heat to the well structure. In some embodiments, the microplate comprises a surrounding environment of the microplate. In some embodiments, the surrounding environment of the microplate comprises one or more of: (i) a mechanical stage supporting the microplate, wherein the mechanical stage is operatively coupled to the microplate; (ii) a liquid handling system arranged to deposit and remove liquid from the microplate, wherein the liquid handing system is positioned above the microplate; (iii) a detection system configured to detect materials from the wells of the well structure; (iv) a thermal control unit operatively coupled to a voltage source; or (v) a computing system configured to manage operations of the mechanical stage, the liquid handling system, and the detection system. In some embodiments, the localized resistive heat does not substantially heat the surrounding environment of the microplate such that the localized resistive heat does not substantially negatively impact optical imaging of materials of the wells by the detection system. In some embodiments, the well structure comprises a material comprising polycarbonate (PC), copolymer, cyclic olefin copolymer (COC), or any combination thereof. In some embodiments, the resistive heating layer comprises a material comprising indium tin oxide (ITO), zinc tin oxide (ZTO), platinum, oxides, carbon nanotubes, or any combination thereof. In some embodiments, the substrate is optically transparent. In some embodiments, the substrate comprises a thickness from about 700 micrometers (μm) to about 1,100 μm. In some embodiments, the resistive heating layer comprises a thickness from about 100 nanometers (nm) to about 200 nm. In some embodiments, the heater further comprises electrical contacts adjacent to and electrically connected with the resistive heating layer. In some embodiments, the heater is configured to generate heat when a voltage is applied across the resistive heating layer. In some embodiments, a temperature of the resistive heating layer is dependent on the applied voltage and resistive properties of the resistive heating layer. In some embodiments, a temperature of the well structure is dependent on the temperature of the resistive heating layer.

Aspects disclosed herein provide fluidics instruments comprising the any one of the microplates disclosed herein, wherein the fluidics instrument comprises the surrounding environment of the microplate, wherein the surrounding environment of the microplate comprises one or more of: (i) a mechanical stage supporting the microplate, wherein the mechanical stage is operatively coupled to the microplate; (ii) a liquid handling system arranged to deposit and remove liquid from the microplate, wherein the liquid handing system is positioned above the microplate; (iii) a detection system configured to detect materials from the wells of the well structure; (iv) a thermal control unit operatively coupled to a voltage source; or (v) a computing system configured to manage operations of the mechanical stage, the liquid handling system, and the detection system. In some embodiments, the localized resistive heat does not substantially heat the surrounding environment of the microplate such that the localized resistive heat does not substantially negatively impact optical imaging of materials of the wells by the detection system. In some embodiments, the well structure comprises a material comprising polycarbonate (PC), copolymer, cyclic olefin copolymer (COC), or any combination thereof. In some embodiments, the resistive heating layer comprises a material comprising indium tin oxide (ITO), zinc tin oxide (ZTO), platinum, oxides, carbon nanotubes, or any combination thereof. In some embodiments, the substrate is optically transparent. In some embodiments, the substrate comprises a thickness from about 700 micrometers (μm) to about 1,100 μm. In some embodiments, the resistive heating layer comprises a thickness from about 100 nanometers (nm) to about 200 nm. In some embodiments, the heater further comprises electrical contacts adjacent to and electrically connected with the resistive heating layer. In some embodiments, the heater is configured to generate heat when a voltage is applied across the resistive heating layer. In some embodiments, a temperature of the resistive heating layer is dependent on the applied voltage and resistive properties of the resistive heating layer. In some embodiments, a temperature of the well structure is dependent on the temperature of the resistive heating layer.

Aspects disclosed herein provide fluidics systems for processing a sample, comprising: (a) a microplate for heating a sample, the microplate comprising: (i) a well structure comprising at least one well configured to support the sample; and (ii) a heater integrated into the microplate, wherein the heater is configured to provide localized resistive heat to the well structure by locally heating both the well structure and the sample; and (iii) a fluidics instrument comprising the microplate and a surrounding environment of the microplate, wherein the surrounding environment of the microplate comprises one or more of: (A) a mechanical stage supporting the microplate, wherein the mechanical stage is operatively coupled to the microplate; (B) a liquid handling system arranged to deposit and remove liquid from the microplate, wherein the liquid handing system is positioned above the microplate; (C) a detection system configured to detect materials from the wells of the well structure; (D) a thermos control unit operatively coupled to a voltage source; (E) a computing system configured to manage the operations of the mechanical stage, the liquid handling system, and the detection system; wherein the localized resistive heat does not substantially heat the surrounding environment of the microplate. In some embodiments, the heater comprises a substrate and a resistive heating layer patterned thereon. In some embodiments, the pattern of the resistive heating layer comprises at least one opening that substantially matches the configuration of the at least one well. In some embodiments, the resistive heating layer comprises a material comprising indium tin oxide (ITO), zinc tin oxide (ZTO), platinum, oxides, carbon nanotubes, or any combination thereof. In some embodiments, the substrate is optically transparent. In some embodiments, the substrate comprises a thickness from about 700 micrometers (μm) to about 1,100 μm. In some embodiments, the resistive heating layer comprises a thickness from about 100 nanometers (nm) to about 200 nm. In some embodiments, the heater further comprises electrical contacts adjacent to and electrically connected with the resistive heating layer. In some embodiments, the heater is configured to generate heat when a voltage is applied across the resistive heating layer. In some embodiments, a temperature of the resistive heating layer is dependent on the applied voltage and resistive properties of the resistive heating layer. In some embodiments, a temperature of the well structure is dependent on the temperature of the resistive heating layer. In some embodiments, the computing system comprises a voltage source. In some embodiments, a voltage from the voltage source is configured to control operation of the heater.

Aspects disclosed herein provide methods for heating a sample comprising: (a) placing a sample in a microplate, wherein the microplate comprises a well structure comprising at least one well configured to support the sample; (b) integrating a heater into the microplate, wherein the heater is configured to provide localized resistive heat to the well structure of the microplate by heating both the well structure and the sample; (c) applying a voltage to the well structure, causing the well structure to generate a localized resistive heat; and (d) locally heating the sample using the localized resistive heat; wherein the localized resistive heat is dependent on an applied voltage and resistive properties of a resistive heating layer of the well structure; and wherein the localized resistive heat does not substantially provide heat to a surrounding environment of the well structure. In some embodiments, the sample is heated to a temperature within a range from about 15 degrees Celsius (° C.) to about 100° C. In some embodiments, locally heating the sample causes a chemical or biological process to occur. In some embodiments, the method further comprises cooling the sample. In some embodiments, the surrounding environment of the microplate comprises one or more of: (i) a mechanical stage supporting the microplate, wherein the mechanical stage is operatively coupled to the microplate; (ii) a liquid handling system arranged to deposit and remove liquid from the microplate, wherein the liquid handing system is positioned above the microplate; (iii) a detection system configured to detect materials from the wells in the well structure; (iv) a thermal control unit operatively coupled to a voltage source; (v) a computing system configured to manage the operations of the mechanical stage, the liquid handling system, and the detection system. In some embodiments, the heater comprises a substrate and a resistive heating layer patterned thereon. In some embodiments, the pattern of the resistive heating layer comprises openings that substantially match the configuration of the at least one well. In some embodiments, the resistive heating layer comprises a material comprising indium tin oxide (ITO), zinc tin oxide (ZTO), platinum, oxides, carbon nanotubes, and combinations thereof. In some embodiments, the substrate is optically transparent. In some embodiments, the substrate has a thickness from about 700 micrometers (μm) to about 1100 μm. In some embodiments, the resistive heating layer comprises a thickness from about 100 nanometers (nm) to about 200 nm. In some embodiments, the heater further comprises electrical contacts adjacent to and electrically connected with the resistive heating layer. In some embodiments, the heater generates heat when a voltage is applied across the resistive heating layer. In some embodiments, a temperature of the resistive heating layer is dependent on the applied voltage and resistive properties of the resistive heating layer. In some embodiments, a temperature of the well structure is dependent on the temperature of the resistive heating layer.

Additionally disclosed herein is a method for heating a sample comprising: (a) placing a sample in a microplate, wherein the microplate comprises a well structure comprising at least one well configured to support the sample, (b) integrating a heater into the microplate, wherein the heater is configured to provide localized resistive heat to the well structure of the microplate by heating both the well structure and the sample, (c) applying a voltage to the well structure, causing the well structure to generate a localized resistive heat, and (d) locally heating the sample using the localized resistive heat, wherein the localized resistive heat is dependent on an applied voltage and resistive properties of a resistive heating layer of the well structure, and wherein the localized resistive heat does not substantially provide heat to a surrounding environment of the well structure. In various embodiments, the heater comprises an optically clear substrate and a resistive heating layer patterned thereon. In various embodiments, the optically clear substrate has a thickness from about 700 micrometers to about 1100 micrometers and the resistive heating layer comprises a thickness from about 100 nanometers to about 200 nanometers. In various embodiments, the resistive heating layer comprises one or more of indium tin oxide, zinc tin oxide, platinum, and carbon nanotubes. In various embodiments, the well structure comprises a material of one or more of polycarbonate, copolymer, and cyclic olefin copolymer. In various embodiments, locally heating the sample causes a chemical or biological process to occur.

In various embodiments, the surrounding environment of the microplate comprises: (i) a mechanical stage supporting the microplate, wherein the mechanical stage is operatively coupled to the microplate, (ii) a liquid handling system arranged to deposit and remove liquid from the microplate, wherein the liquid handling system is positioned above the microplate, (iii) a detection system configured to detect materials from the wells in the well structure, (iv) a thermal control unit operatively coupled to a voltage source, and (v) a computing system configured to manage the operations of the mechanical stage, the liquid handling system, and the detection system.

Additionally disclosed herein is a microplate used for heating a sample, the microplate comprising: (a) a well structure comprising a plurality of wells configured to support a plurality of samples, wherein the well structure comprises a material comprising polycarbonate, copolymer, cyclic olefin copolymer or a combination thereof, (b) a heater integrated into the microplate, wherein the heater integrated into the microplate is configured to provide localized resistive heat to the well structure by heating both the well structure and the plurality of samples, wherein the localized resistive heat does not substantially heat a surrounding environment of the microplate. In various embodiments, the heater comprises a substrate and a resistive heating layer patterned thereon. In various embodiments, the substrate is optically transparent. In various embodiments, the substrate comprises a thickness from about 700 micrometers and to about 1100 micrometers. In various embodiments, the resistive heating layer comprises a thickness of about 100 nanometers to about 200 nanometers. In various embodiments, the resistive heating layer comprises one or more of indium tin oxide, zinc tine oxide, platinum, oxides, and carbon nanotubes. In various embodiments, the heater further comprises electrical contacts adjacent to and electrically connected with the resistive heating layer. In various embodiments, the heater is configured to generate heat when a voltage is applied across the resistive heating layer. In various embodiments, a temperature of the resistive heating layer is dependent on the applied voltage and resistive properties of the resistive heating layer. In various embodiments, a temperature of the well structure is dependent on the temperature of the resistive heating layer.

Additionally disclosed herein is a fluidics system for processing a sample, comprising a microplate for heating a sample, the microplate comprising: (a) a well structure comprising at least one well configured to support the sample, (b) a heater integrated into the microplate, wherein the heater comprises an optically transparent substrate and a resistive heating layer patterned thereon, and wherein the heater is configured to provide localized resistive heat to the well structure by locally heating both the well structure and the sample, and (c) a fluidics instrument comprising the microplate and a surrounding environment of the microplate, wherein the surrounding environment of the microplate comprises one or more of (i) a mechanical stage supporting the microplate, wherein the mechanical stage is operatively coupled to the microplate, (ii) a liquid handling system arranged to deposit and remove liquid from the microplate, wherein the liquid handling system is positioned above the microplate, (iii) a detection system configured to detect materials from the wells of the well structure, (iv) a thermal control unit operatively coupled to a volage source, or (v) a computing system configured to manage the operations of the mechanical stage, the liquid handling system, and the detection system, wherein the localized resistive heat does not substantially heat the surrounding environment of the microplate. In various embodiments, the substrate comprises a thickness from about 700 micrometers to about 1100 micrometers and the resistive heating layer comprises a thickness from about 100 nanometers to about 200 nanometers. In various embodiments, the resistive heating layer comprises a material comprising one or more of indium tin oxide, zinc tin oxide, platinum, oxides, and carbon nanotubes, or any combination thereof.

Additionally disclosed herein is a microplate used for heating a sample, the microplate comprising: (a) a well structure comprising at least one well configured to support the sample; and (b) a heater integrated into the microplate, wherein the heater integrated into the microplate is configured to provide localized resistive heat to the well structure by heating both the well structure and the sample, wherein the localized resistive heat does not substantially heat a surrounding environment of the microplate. In various embodiments, the heater comprises a substrate and a resistive heating layer patterned thereon. In various embodiments, the pattern of the resistive heating layer comprises at least one opening that substantially matches the configuration of the at least one well. In various embodiments, the pattern of the resistive heating layer is configured to allow the heater to provide localized resistive heat to the well structure.

Additionally disclosed herein is a fluidics instrument comprising the microplate disclosed herein, wherein the fluidics instrument comprises the surrounding environment of the microplate, wherein the surrounding environment of the microplate comprises one or more of: (i) a mechanical stage supporting the microplate, wherein the mechanical stage is operatively coupled to the microplate; (ii) a liquid handling system arranged to deposit and remove liquid from the microplate, wherein the liquid handing system is positioned above the microplate; (iii) a detection system configured to detect materials from the wells of the well structure; (iv) a thermal control unit operatively coupled to a voltage source; or (v) a computing system configured to manage operations of the mechanical stage, the liquid handling system, and the detection system.

In various embodiments, the localized resistive heat does not substantially heat the surrounding environment of the microplate such that the localized resistive heat does not substantially negatively impact optical imaging of materials of the wells by the detection system. In various embodiments, the well structure comprises a material comprising polycarbonate (PC), copolymer, cyclic olefin copolymer (COC), or any combination thereof. In various embodiments, the resistive heating layer comprises a material comprising indium tin oxide (ITO), zinc tin oxide (ZTO), platinum, oxides, carbon nanotubes, or any combination thereof. In various embodiments, the substrate is optically transparent. In various embodiments, the substrate comprises a thickness from about 700 micrometers (pm) to about 1,100 pm. In various embodiments, the resistive heating layer comprises a thickness from about 100 nanometers (nm) to about 200 nm. In various embodiments, the heater further comprises electrical contacts adjacent to and electrically connected with the resistive heating layer. In various embodiments, the heater is configured to generate heat when a voltage is applied across the resistive heating layer. In various embodiments, a temperature of the resistive heating layer is dependent on the applied voltage and resistive properties of the resistive heating layer. In various embodiments, a temperature of the well structure is dependent on the temperature of the resistive heating layer.

Additionally disclosed herein is a fluidics system for processing a sample, comprising: (a) a microplate for heating a sample, the microplate comprising: (i) a well structure comprising at least one well configured to support the sample; and (ii) a heater integrated into the microplate, wherein the heater is configured to provide localized resistive heat to the well structure by locally heating both the well structure and the sample; and (iii) a fluidics instrument comprising the microplate and a surrounding environment of the microplate, wherein the surrounding environment of the microplate comprises one or more of: (A) a mechanical stage supporting the microplate, wherein the mechanical stage is operatively coupled to the microplate; (B) a liquid handling system arranged to deposit and remove liquid from the microplate, wherein the liquid handing system is positioned above the microplate; (C) a detection system configured to detect materials from the wells of the well structure; (D) a thermal control unit operatively coupled to a voltage source; or (E) a computing system configured to manage the operations of the mechanical stage, the liquid handling system, and the detection system; wherein the localized resistive heat does not substantially heat the surrounding environment of the microplate.

In various embodiments, the heater comprises a substrate and a resistive heating layer patterned thereon. In various embodiments, the pattern of the resistive heating layer comprises at least one opening that substantially matches the configuration of the at least one well. In various embodiments, the resistive heating layer comprises a material comprising indium tin oxide (ITO), zinc tin oxide (ZTO), platinum, oxides, carbon nanotubes, or any combination thereof. In various embodiments, the substrate is optically transparent. In various embodiments, the substrate comprises a thickness from about 700 micrometers (pm) to about 1,100 pm. In various embodiments, the resistive heating layer comprises a thickness from about 100 nanometers (nm) to about 200 nm. In various embodiments, the heater further comprises electrical contacts adjacent to and electrically connected with the resistive heating layer. In various embodiments, the heater is configured to generate heat when a voltage is applied across the resistive heating layer. In various embodiments, a temperature of the resistive heating layer is dependent on the applied voltage and resistive properties of the resistive heating layer. In various embodiments, a temperature of the well structure is dependent on the temperature of the resistive heating layer. In various embodiments, the computing system comprises a voltage source. In various embodiments, a voltage from the voltage source is configured to control operation of the heater.

Additionally disclosed herein is a method for heating a sample comprising: (a) placing a sample in a microplate, wherein the microplate comprises a well structure comprising at least one well configured to support the sample; (b) integrating a heater into the microplate, wherein the heater is configured to provide localized resistive heat to the well structure of the microplate by heating both the well structure and the sample; (c) applying a voltage to the well structure, causing the well structure to generate a localized resistive heat; and (d) locally heating the sample using the localized resistive heat; wherein the localized resistive heat is dependent on an applied voltage and resistive properties of a resistive heating layer of the well structure; and wherein the localized resistive heat does not substantially provide heat to a surrounding environment of the well structure. In various embodiments, the sample is heated to a temperature within a range from about 15 degrees Celsius (° C.) to about 100° C. In various embodiments, locally heating the sample causes a chemical or biological process to occur. In various embodiments, methods further comprise cooling the sample. In various embodiments, the surrounding environment of the microplate comprises one or more of: (i) a mechanical stage supporting the microplate, wherein the mechanical stage is operatively coupled to the microplate; (ii) a liquid handling system arranged to deposit and remove liquid from the microplate, wherein the liquid handing system is positioned above the microplate; (iii) a detection system configured to detect materials from the wells in the well structure; (iv) a thermal control unit operatively coupled to a voltage source; or (v) a computing system configured to manage the operations of the mechanical stage, the liquid handling system, and the detection system. In various embodiments, the heater comprises a substrate and a resistive heating layer patterned thereon. In various embodiments, the pattern of the resistive heating layer comprises openings that substantially match the configuration of the at least one well. In various embodiments, the resistive heating layer comprises a material comprising indium tin oxide (ITO), zinc tin oxide (ZTO), platinum, oxides, carbon nanotubes, and combinations thereof. In various embodiments, the substrate is optically transparent. In various embodiments, the substrate has a thickness from about 700 micrometers (pm) to about 1100 pm. In various embodiments, the resistive heating layer comprises a thickness from about 100 nanometers (nm) to about 200 nm. In various embodiments, the heater further comprises electrical contacts adjacent to and electrically connected with the resistive heating layer. In various embodiments, the heater generates heat when a voltage is applied across the resistive heating layer. In various embodiments, a temperature of the resistive heating layer is dependent on the applied voltage and resistive properties of the resistive heating layer. In various embodiments, a temperature of the well structure is dependent on the temperature of the resistive heating layer.

### BRIEF DESCRIPTION OF THE DRAWINGS

The features and advantages of the disclosure will be more clearly understood from the following description taken in conjunction with the accompanying drawings, which are not necessarily drawn to scale.

FIG. 1 illustrates a block diagram of an example of a fluidics system including a multi-well microplate with a resistive heater, in accordance with an embodiment of the inventive concepts.

FIG. 2 illustrates a perspective view of an example of a multi-well microplate including the resistive heater of the fluidics system, in accordance with an embodiment of the inventive concepts.

FIG. 3 illustrates an exploded view of an example of a multi-well microplate including the resistive heater of the fluidics system, in accordance with an embodiment of the inventive concepts.

FIG. 4A illustrates a plan view of an example of a pattern of conductive resistive material that may be used to provide a resistive heater in a multi-well microplate.

FIG. 4B illustrates a plan view of an example of a pattern of conductive resistive material that may be used to provide a resistive heater in a multi-well microplate.

FIG. 5 illustrates a perspective view of another example of a multi-well microplate including the resistive heater of the fluidics system.

FIG. 6 illustrates an example of a resistance vs. temperature plot of indium tin oxide (ITO) material.

FIG. 7A illustrates a schematic diagram of an example of a voltage applied to the resistive heater of the multi-well microplate.

FIG. 7B illustrates a schematic diagram of an example of the equivalent circuit of the resistive heater and applied voltage shown in FIG. 7A.

FIG. 8A illustrates a plan view of an example of the resistive heater of the multi-well microplate according to one configuration.

FIG. 8B illustrates a schematic diagram of an example of the resistive heater of the multi-well microplate according to one configuration.

FIG. 9A illustrates a plan view of an example of the resistive heater of the multi-well microplate according to another configuration.

FIG. 9B illustrates a schematic diagram of an example of the resistive heater of the multi-well microplate according to another configuration.

FIG. 10A illustrates a plan view of an example of the resistive heater of the multi-well microplate according to another configuration.

FIG. 10B illustrates a magnified plan view of an example of the resistive heater of the multi-well microplate according to another configuration.

FIG. 10C illustrates a schematic diagram of an example of circuit configurations that use a sensing layer to monitor the temperature of the multi-well microplate including the resistive heater.

FIG. 10D illustrates a schematic diagram of an example of circuit configurations that use a sensing layer to monitor the temperature of the multi-well microplate including the resistive heater.

FIG. 11 illustrates a schematic diagram of an example of a sensing circuit for monitoring the temperature of the resistive heater of the multi-well microplate.

FIG. 12 illustrates a cross-sectional view of an example of a standard multi-well microplate including standard heating and temperature sensing mechanisms.

FIG. 13 illustrates a plot of an example of the operating performance of the standard multi-well microplate and heating configuration shown in FIG. 12.

FIG. 14A illustrates a resistance vs. temperature plot comparing indium tin oxide (ITO) material of the resistive heater with the standard heating and sensing configuration shown in FIG. 12 and FIG. 13.

FIG. 14B illustrates a power vs. time plot of an example of thermal response time.

FIG. 15 illustrates a time vs. temperature plot of an example of the operating performance of the resistive heater of the multi-well microplate according to the configuration shown in FIG. 8A and FIG. 8B.

FIG. 16 illustrates a perspective view of an example of a thermal image showing the measured temperature gradient across a multi-well microplate including a resistive heater.

FIG. 17 illustrates a flow diagram of an example of using a multi-well microplate including a resistive heater, in accordance with an embodiment of the inventive concepts.

FIG. 18 illustrates an exploded view of another example of the multi-well microplate including the resistive heater.

FIG. 19 illustrates a schematic diagram showing a voltage applied to a continuous resistive heating layer of the resistive heater of the multi-well microplate shown in FIG. 18.

### DETAILED DESCRIPTION

Provided herein are microplates used for heating a sample. The microplates may comprise a well structure comprising at least one well configured to support the sample. The microplates may comprise a heater integrated into the microplate, wherein the heater integrated into the microplate is configured to provide localized resistive heat to the well structure by heating both the well structure and the sample. The localized resistive heat may not substantially heat a surrounding environment of the microplate.

Further provided herein are fluidics instruments comprising the microplates disclosed herein. The fluidics instruments may comprise a surrounding environment of the microplate. The surrounding environment of the microplate may comprise a mechanical stage supporting the microplate. The surrounding environment of the microplate may comprise a liquid handling system arranged to deposit and remove liquid from the microplate. The surrounding environment of the microplate may comprise a detection system configured to detect materials from the wells of the well structure. The surrounding environment of the microplate may comprise a thermal control unit operatively coupled to a voltage source. The surrounding environment of the microplate may comprise a computing system configured to manage operations of the mechanical stage, the liquid handling system, and the detection system.

Further provided herein are methods for heating a sample. The method may comprise placing a sample in a microplate, wherein the microplate comprises a well structure comprising at least one well configured to support the sample. The method may comprise integrating a heater into the microplate, wherein the heater is configured to provide localized resistive heat to the well structure of the microplate by heating both the well structure and the sample. The method may comprise applying a voltage to the well structure, causing the well structure to generate a localized resistive heat. The method may comprise locally heating the sample using the localized resistive heat. The localized resistive heat may be is dependent on an applied voltage and resistive properties of a resistive heating layer of the well structure. The localized resistive heat may not be substantially providing heat to a surrounding environment of the well structure. By integrating a heater into a microplate, temperature of the biological analytes and assay reaction conditions can be better controlled and optimized to provide for more robust and reproducible assay conditions.

The methods and systems disclosed herein may be used in detection assays, such as, for example, encoded assays. Examples of encoded assays can be found in WO2023/096674, which is incorporated herein by reference in its entirety.

The subject matter is described more fully hereinafter with reference to the accompanying drawings, in which some, but not all embodiments of the subject matter are shown. Like numbers refer to like elements throughout. The subject matter may be embodied in many different forms and may not be construed as limited to the embodiments set forth herein; rather, these embodiments are provided so that this disclosure will satisfy applicable legal requirements.

Many modifications and other embodiments of the subject matter set forth herein will come to mind to one skilled in the art to which the subject matter pertains having the benefit of the teachings presented in the descriptions and the associated drawings. Therefore, it is to be understood that the subject matter is not to be limited to the specific embodiments disclosed and that modifications and other embodiments are intended to be included within the scope of the appended claims.

In some embodiments, the subject matter provides a fluidics system, microplate, and method including integrated resistive heating. In some embodiments, the fluidics system, microplate, and method including integrated resistive heating provides a fluidics system including a microplate along with, for example, a mechanical stage, a liquid handling system, a detection system, and a computing system; and of which may be arranged, for example, in a fluidics instrument.

In some embodiments, the fluidics system, microplate, and method including integrated resistive heating may provide a microplate including a multi-well structure and a heater integrated into the multi-well structure and wherein the heater may be a resistance-based heater that provides localized heating with respect to the multi-well structure and for achieving a temperature to perform chemical reactions efficiently. In some embodiments, the fluidics system, microplate, and method including integrated resistive heating provides a microplate including a multi-well structure and a heater integrated into the multi-well structure and wherein the heater may include a resistive heating layer patterned on a substrate.

In some embodiments, the fluidics system, microplate, and method including integrated resistive heating may provide a microplate including a multi-well structure and a heater integrated into the multi-well structure and wherein the heater may include a resistive heating layer patterned on a substrate and wherein the resistive heating layer pattern substantially matches the pattern of wells in the multi-well structure.

In some embodiments, the fluidics system, microplate, and method including integrated resistive heating may provide a microplate including a heater including a resistive heating layer patterned on a substrate and wherein the resistive heating layer may be an electrically conductive and resistive material having temperature-dependent resistance.

In some embodiments, the fluidics system, microplate, and method including integrated resistive heating may provide a microplate including a heater including a resistive heating layer patterned on a substrate and wherein a voltage may be applied across the resistive heating layer and wherein the voltage induces current though the resistive heating layer and heat is generated by power dissipation.

In some embodiments, the fluidics system, microplate, and method including integrated resistive heating may provide a microplate including a heater wherein heat is generated by power dissipation and wherein a feedback loop is provided for achieving and/or maintaining a target temperature and wherein the target temperature may be, for example, from about 15° C. to about 100° C.

In some embodiments, the fluidics system, microplate, and method including integrated resistive heating may provide a microplate including a heater including a resistive heating layer patterned on a substrate and wherein the resistive heating layer may be formed of, for example, indium tin oxide (ITO), zinc tin oxide (ZTO), platinum, any conductive oxide material that has resistive properties, carbon nanotube-based films that have resistive properties, any kind of resistive thin film, and the like. In some embodiments, the fluidics system, microplate, and method including integrated resistive heating provides a microplate including a heater including a resistive heating layer (e.g., ITO, ZTO, or platinum layer) patterned on a substrate and wherein the resistive heating layer may include openings that substantially match the pattern of wells in the multi-well well structure.

In some embodiments, the fluidics system, microplate, and method including integrated resistive heating may provide a consumable microplate including a heater that may be used to provide a simplified fluidics system and/or instrument (e.g., less heating and cooling mechanisms) compared with existing fluidics systems and/or instruments.

In some embodiments, the fluidics system, microplate, and method including integrated resistive heating may provide a microplate including a heater that may be used to provide fast thermal response time and thereby allow rapid temperature cycling.

Further, a method of using the microplate including a multi-well structure and heater is provided.

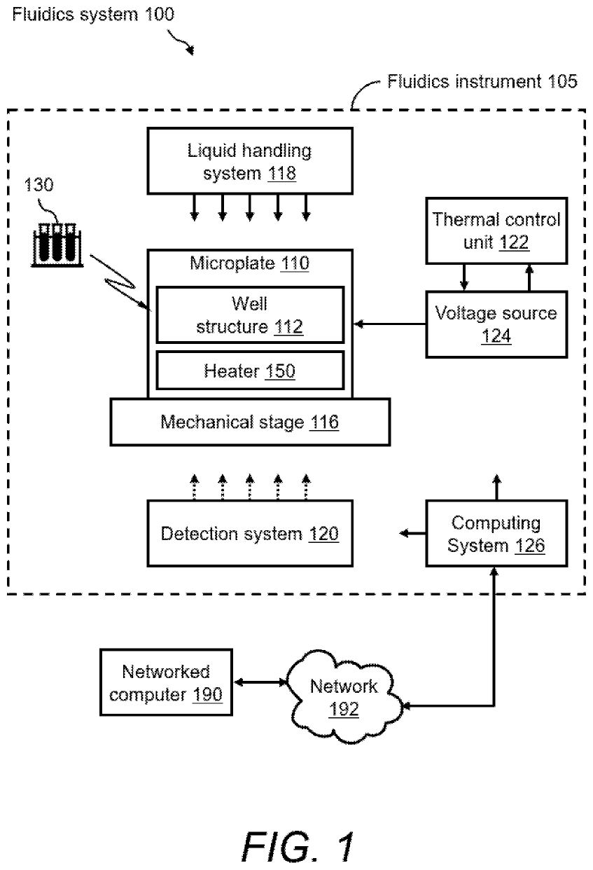

FIG. 1 is a block diagram of an example of fluidics system 100 including a multi-well microplate with an integrated resistive heater. For example, fluidics system 100 may include a fluidics instrument 105 that houses a microplate 110 among other components and/or subsystems that may be found in fluidics or microfluidics instruments.

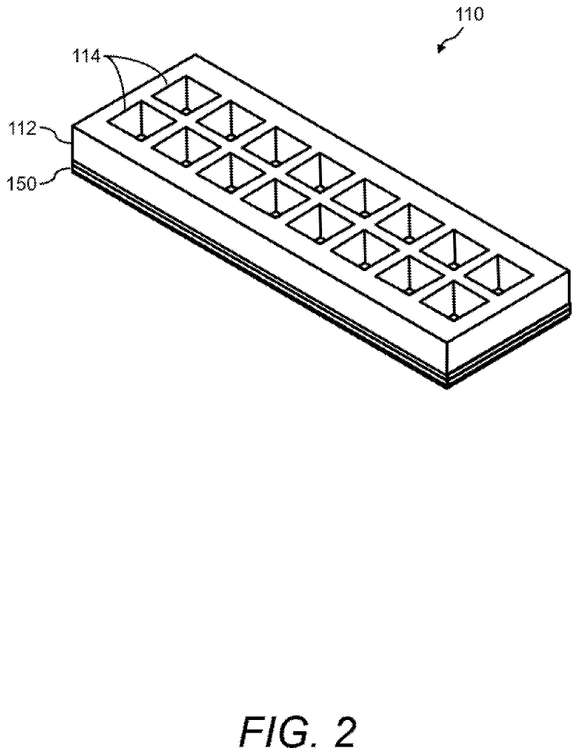

Microplate 110 may further include a well structure 112 and a heater 150. Well structure 112 may be, for example, a multi-well microplate (e.g., multiple wells 114 of FIG. 2). For example, the number of wells 114 may range from about 12 to about 1536. In some embodiments, the number of wells may comprise more than or equal to 2, 4, 6, 8, 10, 12, 14, 18, 20, 24, 32, 40, 48, 56, 64, 72, 80, 96, 100, 200, 300, 384, 400, 500, 600, 700, 800, 900, 1000, 1100, 1200, 1300, 1400, 1500, 1536, 1600, 1700, 1800, 1900, or 2000 wells. In some embodiments, the number of wells may comprise less than or equal to 2000, 1900, 1800, 1700, 1600, 1536, 1500, 1400, 1300, 1200, 1100, 1000, 900, 800, 700, 600, 500, 400, 384, 300, 200, 100, 96, 80, 72, 64, 56, 48, 40, 32, 24, 20, 18, 14, 12, 10, 8, 6, 4, or 2 wells. Further, heater 150 may be a layer of electrically conductive and resistive material that is thermally coupled to one surface or well structure 112. Accordingly, in microplate 110, heater 150 may be a resistance-based heater that provides localized heating with respect to well structure 112. More details of examples of a microplate 110 including well structure 112 and heater 150 are shown and described herein with reference to FIG. 2 through FIG. 10D.

In fluidics instrument 105, microplate 110 may be arranged atop a mechanical stage 116. Mechanical stage 116 may be, for example, any X-Y-Z stage for translating microplate 110 in any X-Y-Z direction. In well structure 112, the wells 114 of the multi-well microplate open upward. Accordingly, fluidics instrument 105 may include a liquid handling system 118 arranged above a microplate 110. Liquid handling system 118 may be, for example, a robotics-based pipette system. Further, certain chemical and biological processes occur in the wells of well structure 112. Accordingly, certain chemistry 130 may be present in the wells of well structure 112.

Additionally, a detection system 120 may be provided in fluidics instrument 105 and in relation to microplate 110. In one example, detection system 120 may be arranged below microplate 110. Detection system 120 may be any detection mechanism that can be used to accurately determine the presence or absence of a defined analyte and/or target component in different materials. Additionally, detection system 120 may be used to quantify the amount of analyte and/or target components present in a sample. Detection system 120 may be, for example, an optical measurement system that includes an illumination source (not shown) and an optical measurement device (not shown).

The illumination source of an optical detection system 120 may be, for example, a light source for the visible range (400-800 nanometers (nm)), such as, but not limited to, a white light-emitting diode (LED), a halogen bulb, an arc lamp, an incandescent lamp, lasers, and the like. The optical measurement device of an optical detection system 120 may be used to obtain light intensity readings. The optical measurement device may be, for example, a charge coupled device, a photodetector, a spectrometer, a photodiode array, or any combinations thereof. In one example, an optical detection system 120 may be a fluorimeter that provides both excitation and detection. An opening (not shown) in mechanical stage 116 may allow unobstructed line-of-sight from optical detection system 120 to microplate 110.

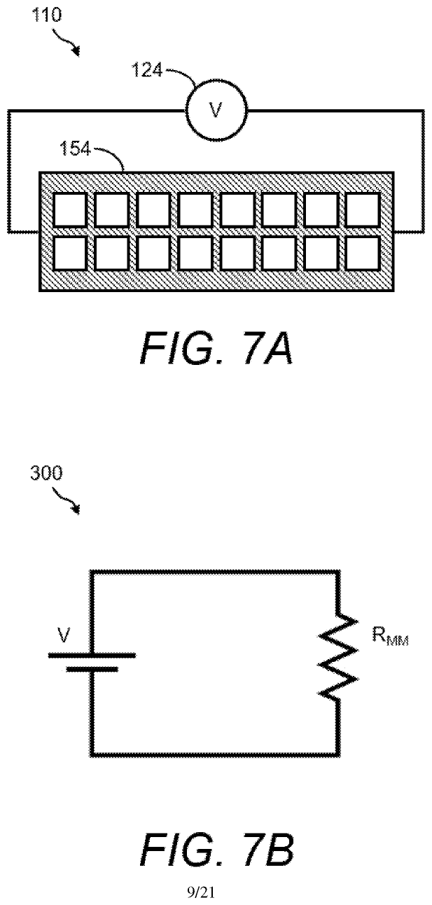

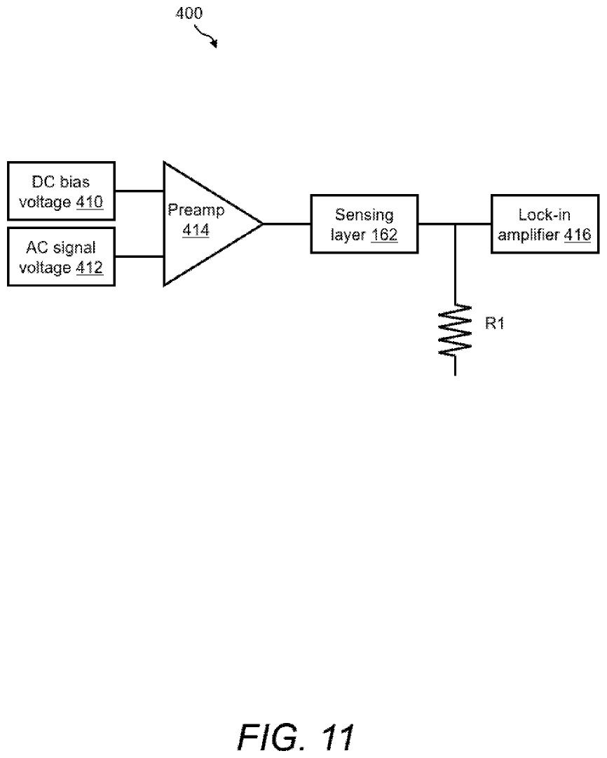

Existing chemical and biological processes may require precise and stable temperature control for optimal efficiency and performance. Accordingly, a thermal control unit 122 and a voltage source 124 may be provided in fluidics instrument 105. For example, in microplate 110, a voltage from voltage source 124 is used to control the operation of heater 150. Thermal control unit 122 may be used to control voltage source 124 and to process any feedback from heater 150 with respect to holding microplate 110 at a certain temperature and/or cycling the temperature of microplate 110. Voltage source 124 may be, for example, a power supply module for providing a DC voltage across heater 150 of microplate 110 (see FIG. 7A through FIG. 10D). Voltage source 124 may also have capability to provide DC current information as a feedback mechanism to thermal control unit 122. Another example of a feedback mechanism for controlling the temperature of microplate 110 is shown with reference to FIG. 11.

A computing system 126 may be provided in fluidics instrument 105. Computing system 126 may, for example, be a general-purpose computer, special purpose computer, personal computer, microprocessor, or other programmable data processing apparatus. Computing system 126 may provide processing capabilities, such as storing, interpreting, and/or executing software instructions, as well as controlling the overall operations of fluidics system 100. The software instructions may comprise machine readable code stored in non-transitory memory that is accessible by the computing system 126 for the execution of the instructions. Computing system 126 may be configured and programmed to control data and/or power aspects of fluidics system 100. Further, data storage (not shown) may be built into or provided separate from computing system 126. Computing system 126 may be used to manage any functions of fluidics system 100. For example, computing system 126 may be used to manage the operations of mechanical stage 116, liquid handling system 118, detection system 120, thermal control unit 122, voltage source 124, and any other instrumentation (not shown) in relation to microplate 110.

In other embodiments of fluidics system 100, the functions of computing system 126, detection system 120, thermal control unit 122, voltage source 124, and/or any other instrumentation may be integrated directly into microplate 110 rather than provided separately from microplate 110.

Optionally, fluidics instrument 105 may be connected to a network. For example, computing system 126 may be in communication with a networked computer 190 via a network 192. Networked computer 190 may be, for example, any centralized server or cloud-based server. Network 192 may be, for example, a local area network (LAN) or wide area network (WAN) for connecting to the internet.

Referring still to FIG. 1, the general operation of fluidics system 100 with respect to microplate 110 including heater 150 may be as follows. A microplate 110 is provided atop mechanical stage 116 in fluidics instrument 105. Each of the wells 114 of well structure 112 of microplate 110 may be loaded with certain chemistry(ies) 130. Using liquid handling system 118, sample liquid, for example, may be loaded into each of the wells 114 of well structure 112 of microplate 110. Microplate 110 is heated to a certain precise and stable operating temperature using heater 150. More specifically, under the control of thermal control unit 122, voltage source 124 provides a DC voltage to heater 150, which is a resistive heater. In heater 150, a certain input DC voltage value may correlate to a certain operating temperature. This causes current to flow through the resistive heater 150. The current flow generates heat that is transferred to well structure 112 of microplate 110. Thermal control unit 122 may be used to continuously monitor feedback from heater 150 with respect to holding microplate 110 at a certain temperature and/or cycling the temperature of microplate 110.

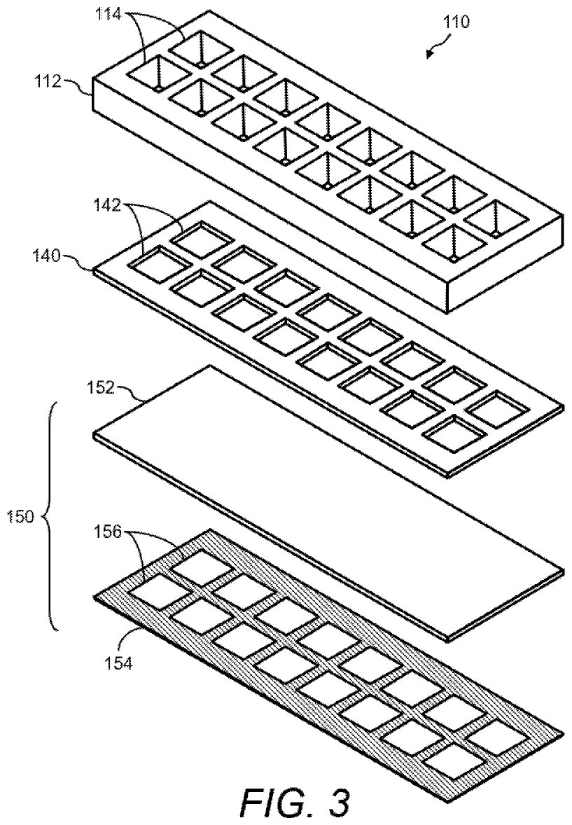

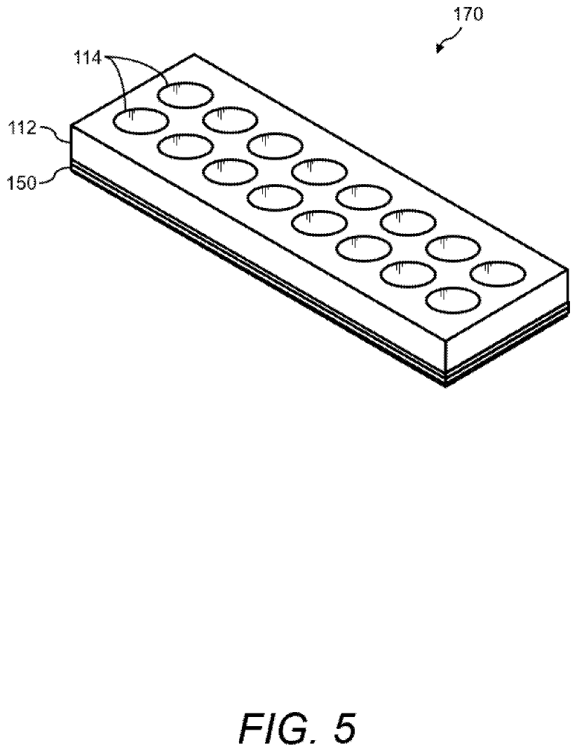

Referring to FIG. 2 and FIG. 3 is a perspective view and an exploded view, respectively, of microplate 110. Microplate 110 is an example of a multi-well microplate with an integrated resistive heater of fluidics system 100. For example, microplate 110 may include well structure 112 that has an arrangement of multiple wells 114. Well structure 112 may be formed, for example, of polycarbonate (PC) materials, copolymer materials, cyclic olefin copolymer (COC) materials, and the like. In this example, well structure 112 has an arrangement of sixteen wells 114, which is two lines of eight wells 114. In this example, each of the wells 114 may be square-shaped or rectangular-shaped. However, other shapes are possible, such as cylindrical-shaped wells 114 as shown in FIG. 5. Further, the number of wells 114 may range, for example, from about 12 to about 1536 wells.

Heater 150 of microplate 110 may include a substrate 152 that has a resistive heating layer 154 patterned thereon. Further, resistive heating layer 154 may include a pattern of openings 156 that substantially matches the pattern of wells 114 of well structure 112. Substrate 152 may be any substantially transparent substrate, such as a glass or plastic substrate. Resistive heating layer 154 may be formed of any electrically conductive and resistive material. For example, resistive heating layer 154 may be formed of ITO, ZTO, platinum, any conductive oxide material that has resistive properties, carbon nanotube-based films that have resistive properties, any kind of resistive thin film, and the like. In one example, resistive heating layer 154 may be deposited atop substrate 152. Deposition of these materials may be with plasma-enhanced chemical vapor deposition (PECVD), radio frequency (RF) sputtering, direct current (DC) sputtering, evaporation, E-beam, or any other standard semiconductor thin film deposition systems. Specifically for patterning of the film before (sacrificial layer with lift off) or after deposition (etch mask). Further, etching techniques, such as laser etching, reactive ion etching (RIE), and other existing semiconductor processing techniques, may be used. A glass substrate 152 may be from about 170 μm to about 1000 μm thick in one example or may be about 1100 μm thick in another example. An ITO resistive heating layer 154 may be from about 100 nm to about 500 nm thick in one example or may be about 200 nm thick in another example.

In microplate 110, the substrate 152-side of heater 150 may be oriented toward well structure 112. Therefore, the resistive heating layer 154-side of heater 150 may be oriented away from well structure 112. Further, a coupling layer 140 may be provided between substrate 152 of heater 150 and well structure 112. Further, coupling layer 140 may include openings 142 that substantially match the pattern of wells 114 of well structure 112. Coupling layer 140 may be, for example, a thermally conductive gasket material or a thermally conductive adhesive layer. More specifically, coupling layer 140 may be an epoxy, acrylate, or other adhesive, and may come in foam or liquid form. Additionally, coupling layer 140 may be absent an adhesive, using instead other available glass-plastic bonding technologies. When fully assembled, microplate 110 is a stack from bottom to top of resistive heating layer 154, then substrate 152, then coupling layer 140, then well structure 112. Accordingly, substrate 152 may form the floor of each of the wells 114 of well structure 112.

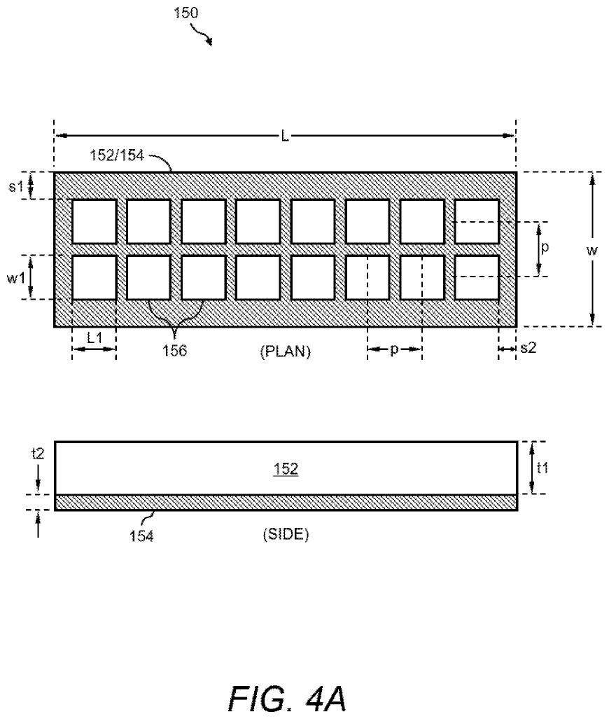

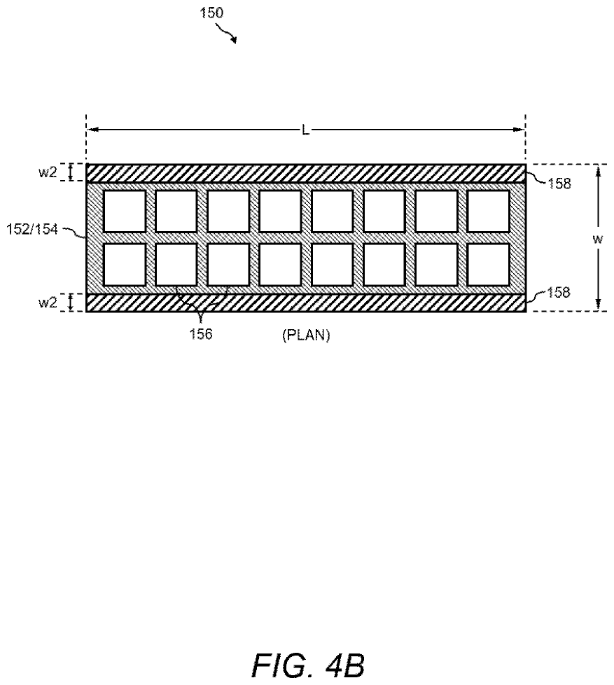

Referring now to FIG. 4A and FIG. 4B is plan views of an example of a heater 150 including substrate 152 and the integrated resistive heating layer 154, which is a pattern of conductive resistive material. In this example, FIG. 4A shows that heater 150 may have a length L and a width w. Each of the openings 156 has a length L1 and a width w1. Further, the openings 156 are arranged on a pitch p. Further, there is a space s1 between the openings 156 and the side edge of heater 150. Further, there is a space s2 between the openings 156 and the end edge of heater 150. Further, substrate 152 has a thickness t1. Further, resistive heating layer 154 has a thickness t2.

In one example, the dimensions of heater 150 may be as follows:
length L of heater 150=about 75.8 mm;
width w of heater 150=about 25 mm;
length L1 of openings 156=about 7 mm;
width w1 of openings 156=about 7 mm;
pitch p of openings 156=about 9 mm;
space s1=about 4.5 mm;
space s2=about 2.9 mm;
thickness t1 of a glass substrate 152=about 1000 μm; and
thickness t2 of an ITO resistive heating layer 154=about 200 nm.

While the examples provided show that the glass may be about 25 mm×75 mm, the geometry of the glass may vary. For example, the integrated resistive heating of the disclosure may be extended to larger formats. For example, standard plate formats may be about 110 mm by about 74 mm in x and y.

Further, FIG. 4B shows an example of heater 150 including a pair of electrical contacts or busbars 158 along the side edges of resistive heating layer 154. Each of the electrical contacts or busbars 158 may have a width w2. In one example, width w2=about 3 mm.

Referring now to FIG. 5 is a perspective view of an example of a microplate 170, which is another example of a multi-well microplate with an integrated resistive heater of fluidics system 100. That is, microplate 170 is substantially the same as microplate 110 described herein with reference to FIG. 2, FIG. 3, and FIG. 4, except that well structure 112 of microplate 170 includes cylindrical wells 114 instead of square or rectangular wells 114. Accordingly, openings 142 of coupling layer 140 and openings 156 of resistive heating layer 154 (not visible) may be substantially circular to match the wells 114 in microplate 170.

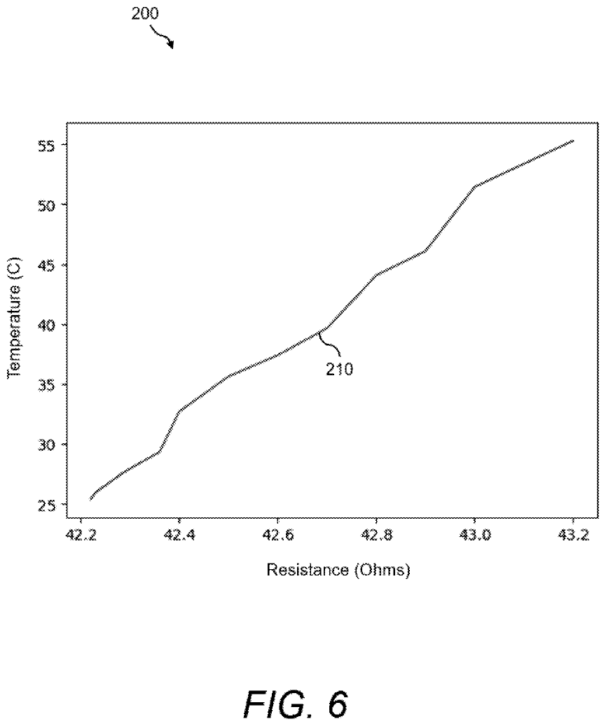

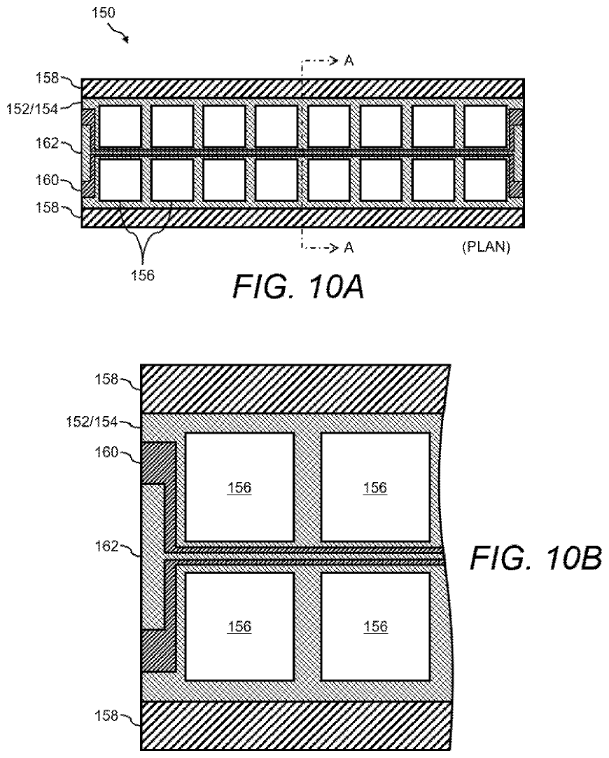

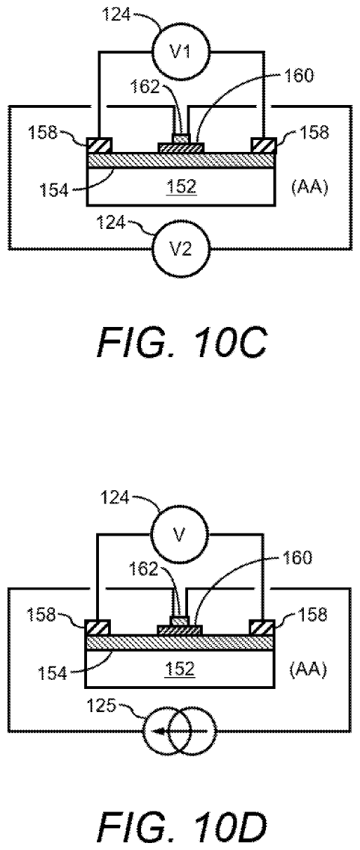

Referring now to FIG. 6 is a graph 200, which is an example of a resistance vs. temperature plot of ITO material. Graph 200 shows curve 210 of resistance vs. temperature for ITO material, which demonstrates a substantially linear relationship. For example, temperature-dependent resistance may be characterized by measuring the resistance of ITO as the hot side of glass cools down. From this and knowing Ohm's Law of V=IR, the temperature of, for example, ITO patterned on glass may be calculated. In one example, the temperature of, for example, ITO patterned on glass may be calculated by monitoring the current induced by a voltage, as described herein in FIG. 10C. In another example, the temperature of, for example, ITO patterned on glass may be calculated by monitoring the voltage developed by a certain current flow, as described herein in FIG. 10D.

Referring now to FIG. 7A is a schematic diagram of an example of a voltage applied to the heater 150 of microplate 110. In this example, a DC voltage V from voltage source 124 may be used to induce current though the patterned resistive heating layer 154 (e.g., ITO resistive heating layer 154). Further, FIG. 7B shows a schematic diagram of an example of an equivalent circuit 300 of the resistive heating layer 154 of heater 150 and the applied voltage shown in FIG. 7A. That is, equivalent circuit 300 shows the voltage V across a resistance R_{MM} (R-microplate).

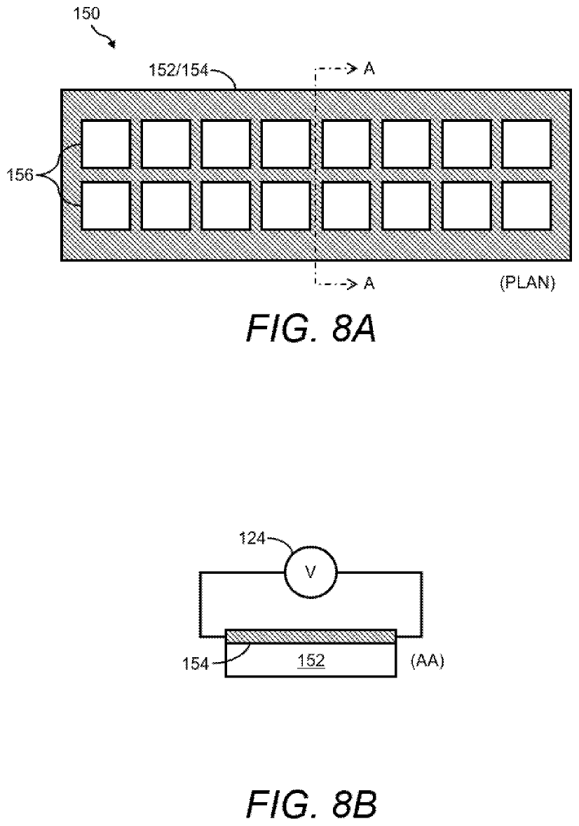

Referring now to FIG. 8A and FIG. 8B is a plan view and a schematic diagram, respectively, of an example of the integrated resistive heater (e.g., heater 150) of the multi-well microplate (e.g., microplate 110) according to one configuration. In this example, FIG. 8A shows heater 150 in a simplest configuration that includes the patterned resistive heating layer 154 alone on one surface of substrate 152. FIG. 8B is a cross-sectional view of heater 150 taken along line AA of FIG. 8A. Further, FIG. 8B shows, in schematic diagram form, voltage V from voltage source 124 across the physical span of resistive heating layer 154. That is, voltage V may be electrically connected directly to opposite sides or ends or corners of resistive heating layer 154. Again, the voltage V induces current though resistive heating layer 154, which has a temperature-dependent resistance, and heat is generated by power dissipation. Heat may be generated by power dissipation of current through a resistive material (P=I²R or Power=Current squared×Resistance). In this configuration, fluidics instrument 105 may be interfaced by pressing metal leads directly to the surface of resistive heating layer 154 and thereby creating electrical contact. In operation, the amount of heat generated substantially correlates to the value of voltage V. For example, the higher the voltage value the greater the temperature of resistive heating layer 154 and accordingly of microplate 110.

Referring still to FIG. 8B, in operation, apply a voltage V to resistive heating layer 154, then measure the current in resistive heating layer 154, and then calculate the resistance of resistive heating layer 154. Then, correlate the calculated resistance to a temperature based on the resistance properties of the material forming resistive heating layer 154. As the resistance changes with temperature, voltage V may be adjusted to achieve and/or maintain a target temperature. All the while, continue monitoring the current in resistive heating layer 154 to derive the temperature of resistive heating layer 154 and accordingly of microplate 110. For example, thermal control unit 122 and/or voltage source 124 may have a current meter function to measure the current flow through resistive heating layer 154. Accordingly, the temperature control of microplate 110 is substantially dependent on the resistive properties of the material (e.g., ITO, ZTO, platinum) forming resistive heating layer 154.

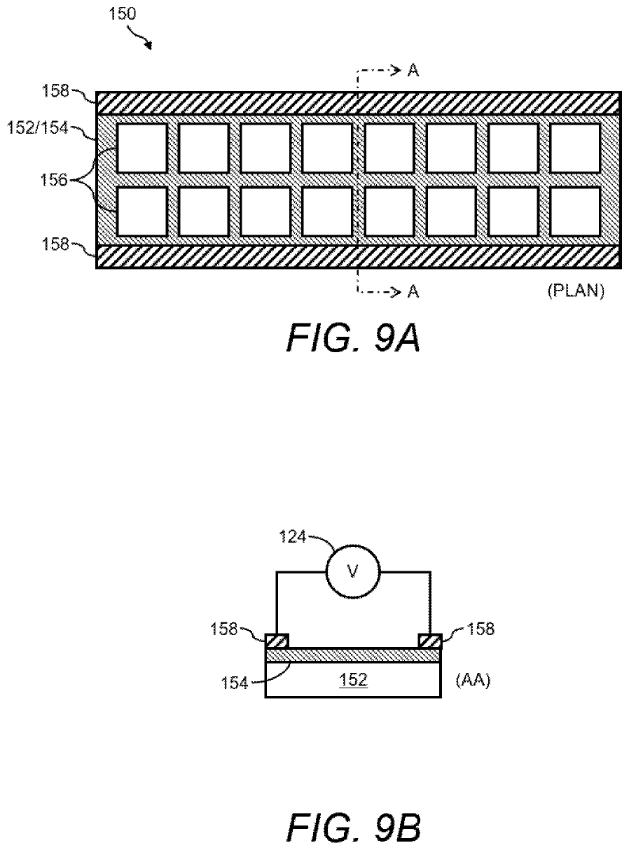

Referring now to FIG. 9A and FIG. 9B is a plan view and a schematic diagram, respectively, of an example of the integrated resistive heater (e.g., heater 150) of the multi-well microplate (e.g., microplate 110) according to another configuration. FIG. 9B is a cross-sectional view of heater 150 taken along line AA of FIG. 9A For example, FIG. 9A shows that this configuration of heater 150 is substantially the same as the configuration shown in FIG. 8A and FIG. 8B except for the addition of electrical contacts or busbars 158 deposited along the side edges of resistive heating layer 154. Electrical contacts or busbars 158 may be formed of any metal or metal alloys having high electrical conductivity, such as gold, silver, copper, platinum, palladium, and the like. Compared with the configuration shown in FIG. 8A and FIG. 8B, the electrical contacts or busbars 158 deposited on resistive heating layer 154 improves electrical conductivity between resistive heating layer 154 and the fluidics instrument 105 interface. Further, with respect to FIG. 9B, the operation of heater 150 is substantially the same as the operation of heater 150 shown and described in FIG. 8B.

Referring now to FIG. 10A and FIG. 10B is a plan view and a schematic diagram, respectively, of an example of the integrated resistive heater (e.g., heater 150) of the multi-well microplate (e.g., microplate 110) according to yet another configuration. FIG. 10B is a cross-sectional view of heater 150 taken along line AA of FIG. 10A. For example, FIG. 10A shows that this configuration of heater 150 is substantially the same as the configuration shown in FIG. 9A and FIG. 9B except for the addition of a passivation layer 160 deposited atop resistive heating layer 154 and then a sensing layer 162 deposited atop passivation layer 160. Passivation layer 160 may be an insulating layer formed, for example, of any non-conductive nitride or oxide layer, such as silicon nitride, silicon dioxide, and the like. Sensing layer 162 may be formed of any electrically conductive material having a temperature-dependent resistance. For example, sensing layer 162 may be formed of ITO, ZTO, platinum, copper, and the like. Further, FIG. 10B shows a magnified view of one end of heater 150 shown in FIG. 10A showing more details of passivation layer 160 and sensing layer 162.

In fluidics system 100, the temperature-dependent resistance of sensing layer 162 of heater 150 may be monitored, and in effect monitoring the temperature of microplate 110. Examples of circuit configurations that use sensing layer 162 to monitor the temperature of microplate 110 are shown in FIG. 10C and FIG. 10D. For example, the temperature-dependent resistance may be monitored by (1) imposing a voltage and then measuring the current drawn (see FIG. 10C), or (2) sourcing a current then measuring the voltage drop (see FIG. 10D). Further, the circuit configurations shown in FIG. 10C and FIG. 10D may rely on the temperature-dependent resistance of the material (e.g., ITO) forming sensing layer 162. Again, an example of the linear relationship of resistance vs. temperature for ITO is shown above in graph 200 of FIG. 6.

In one example, in schematic diagram shown in FIG. 10C, a voltage V1 from voltage source 124 may be electrically connected to electrical contacts or busbars 158 atop resistive heating layer 154. The voltage V1 induces current though resistive heating layer 154, which has a temperature-dependent resistance, and heat is generated by power dissipation. Similarly, a voltage V2 from voltage source 124 may be electrically connected across sensing layer 162, which has temperature-dependent resistance. While voltage V1 and resistive heating layer 154 are used to affect heating, by contrast, voltage V2 and sensing layer 162 may be used to derive the temperature that results from the heating of resistive heating layer 154. The voltage V2 applied to sensing layer 162 may be from about 0.1 volts DC to about 1 volt DC in one example, or about 10 volts DC in another example.

Referring still to FIG. 10C, in operation, apply a constant voltage V2 to sensing layer 162, measure the current in sensing layer 162, and calculate the resistance of sensing layer 162. Correlate the calculated resistance to a temperature based on the resistance properties of the material forming sensing layer 162 (again see FIG. 6). As the resistance changes with temperature, hold voltage V2 constant and continue monitoring the current in sensing layer 162 to derive temperature. For example, thermal control unit 122 and/or voltage source 124 may have a current meter function to measure the current flow through resistive heating layer 154 and/or sensing layer 162. In another example, in schematic diagram shown in FIG. 10D, the voltage V from voltage source 124 may be electrically connected to electrical contacts or busbars 158 atop resistive heating layer 154. The voltage V induces current though resistive heating layer 154, which has a temperature-dependent resistance, and heat is generated by power dissipation.

Additionally, using a constant current source 125, a constant current may be induced through (from end-to-end) sensing layer 162. While voltage V and resistive heating layer 154 are used to affect heating, by contrast, constant current source 125 and sensing layer 162 may be used to derive the temperature that results from the heating of resistive heating layer 154. The amount of constant current in sensing layer 162 may be from about 1 milliamp to about 100 milliamps in one example, or about 1000 milliamps in another example.

Referring still to FIG. 10D, in operation, with constant current present, the voltage across sensing layer 162 changes when the resistance of sensing layer 162 changes. The resistance of sensing layer 162 changes because the temperature of resistive heating layer 154 and sensing layer 162 changes. For example, thermal control unit 122 and/or voltage source 124 may have a voltmeter function to measure the voltage across sensing layer 162. The voltage measurement across sensing layer 162 may be correlated to a temperature with respect to the material that sensing layer 162 is formed of. This is because the material forming sensing layer 162 has temperature-dependent resistance. That is, as the temperature changes, the resistance of sensing layer 162 changes (again see FIG. 6).

In yet another configuration (not shown), heater 150 may include resistive heating layer 154 atop substrate 152, passivation layer 160 atop resistive heating layer 154, and sensing layer 162 atop passivation layer 160, but absent electrical contacts or busbars 158.

In any of the configurations shown in FIG. 8A through FIG. 10D, voltage source 124 may be used to impose the voltage V across resistive heating layer 154 of heater 150. At the same time, the induced current may be monitored, either the current through resistive heating layer 154 itself (see FIG. 8B, FIG. 9B) or through sensing layer 162 (see FIG. 10B).

Then, the resistance R may be calculated by

$$R = V / I . \qquad [ Equation 1 ]$$

where V is voltage and I is current;

Then, the temperature may be derived by

$$T = m R + b ; \qquad [ Equation 2 ]$$

where m is the slope of the line and b is a constant derived from the intercept.

Based on the linear curve 210 of graph 200 of FIG. 6, it can be seen that the resistance correlates with the temperature; as temperature increases so does resistance. Here, the linear Equation 2 describes the temperature: Temperature=(slope of line)*(resistance)+(constant term).

FIG. 11 illustrates a schematic diagram of an example of a sensing circuit 400 for monitoring the temperature of the integrated resistive heater (e.g., heater 150) of the multi-well microplate (e.g., microplate 110). Circuit 400 uses a differential conductance technique where a DC bias 410 is superimposed with an AC signal voltage 412. The amplitude of 412 is such that it is much less than the DC offset of 410. DC bias 410 and AC signal 412 are coupled by preamp 414. In this way, the DC component induces a current in sensing layer 162, and the AC voltage drop between sensing layer 162 and R1 is detected by the lock-in amplifier 416. In one example, voltage source 124 of fluidics system 100 may include sensing circuit 400. Sensing circuit 400 may be used to provide temperature monitoring of microplate 110 using an AC lock-in technique. In one example, sensing circuit 400 may include a DC bias voltage 410 and an AC signal voltage 412 and both feeding a preamp 414. The output of preamp 414 is an AC signal with a DC offset that excites the resistive temperature device (RTD) 162 of the heater. The node between RTD 162 and R1 of 400 form a voltage divider where lock-in amplifier 416 measures the AC component 414.

In sensing circuit 400, DC bias voltage 410 will impose a large voltage and induce current through sensing layer 162 of heater 150 and causing heat dissipation through power. Further, the signal out of AC signal voltage 412 will be a small AC amplitude with frequencies at about 100 Hz. It is a small signal that may not modulate the electrical properties of sensing layer 162 of heater 150. Lock-in amplifier 416 may compose of a signal multiplier that may be used to filter out signals that are not equal to the frequency of the AC signal of AC signal voltage 412, allowing sensitive measurements of voltage. Further, a node between RTD 162 and an existing resistance R1 produces a voltage drop that is measured by 416, allowing the resistance of sensing layer 162 to be calculated by Ohm's law.

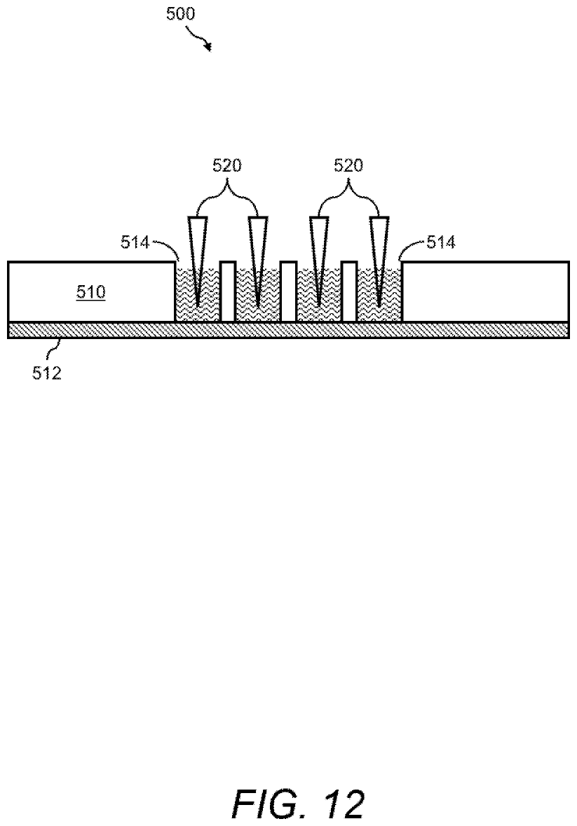

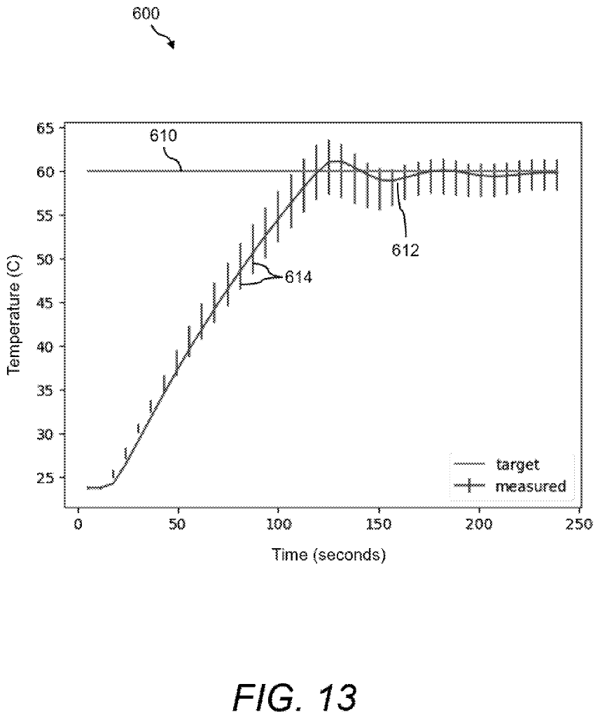

Referring now to FIG. 12 is a cross-sectional view of an example of a standard multi-well microplate 500 and including standard heating and temperature sensing mechanisms. In this example, the standard multi-well microplate 500 may include a well structure 510 mounted on a substrate 512. For illustration purposes, well structure 510 may include four wells 514 and holding certain liquid (chemistry) therein. This is example, and well structure 510 may include any number of wells 514, such as from about 12 to about 1536 wells 514. In one example, well structure 510 may include sixteen wells 514. In standard instrument configurations, the environment holding the standard multi-well microplate 500 may be an entirely heated environment with a slow heating response time. Further, to monitor the temperature of the chemistry, a thermocouple 520 may be provided in each of the four wells 514. The output of the four thermocouples 520 may be monitored using an external computing system (not shown). In one example, in standard multi-well microplate 500, the temperature at wells 514 may be dependent on the temperature of the heated environment in its entirety. Further to the example, FIG. 13 shows a graph 600 of an example of the operating performance of the standard multi-well microplate 500 and heating configuration shown in FIG. 12. For example, graph 600 may represent a temperature proportional-integral-derivative, or PID, loop of the standard multi-well microplate 400 and heating configuration. Graph 600 may include a target temperature line 610 (e.g., 60° C.). A curve 612 of graph 600 indicates the average measured temperature using the four thermocouples 520 shown in FIG. 12. Further, there is a series of vertical lines 614 along curve 612. Each of the vertical lines 614 is the measurement range at a given time of the four thermocouples 520 from which the average (e.g., curve 612) is derived. Further, when using the standard multi-well microplate 500 and heating configuration shown in FIG. 12, curve 612 of graph 600 shows that it may take minutes to ramp up to the target temperature.

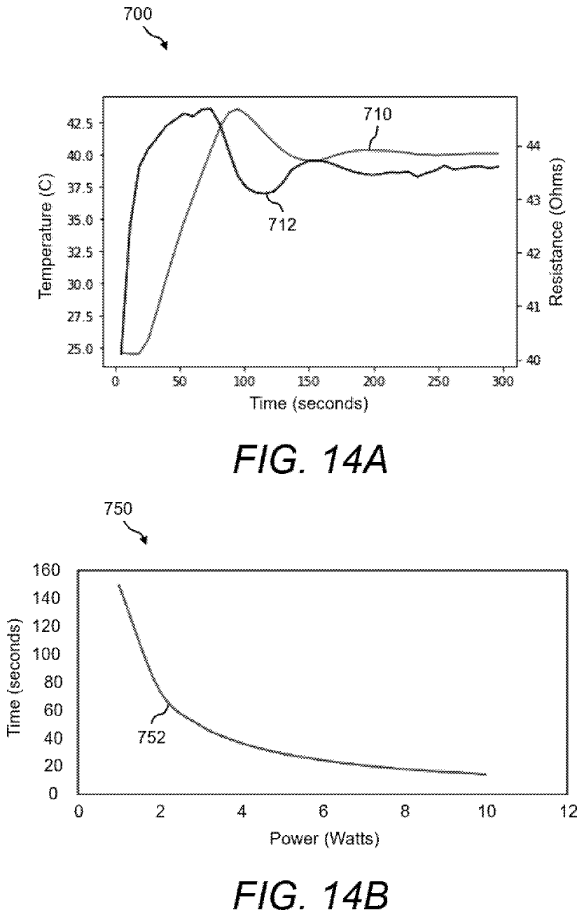

Referring now FIG. 14A is a graph 700 comparing ITO material of the integrated resistive heater (e.g., heater 150) compared with the standard heating and sensing configuration shown in FIG. 12 and FIG. 13. Microplate 110 that includes well structure 112 and heater 150 provides a rapid temperature response time compared with existing microplate and heating configurations, such as shown in FIG. 12 and FIG. 13. More specifically, graph 700 shows a temperature vs. time curve 710 of the standard multi-well microplate 400 and heating configuration. Further, graph 700 shows a resistance vs. temperature vs. time curve 712 of microplate 110 including heater 150. In fluidics system 100, ITO resistance may be used as PID feedback. Graph 700 shows a significantly faster temperature ramp up or response time for microplate 110 compared with the standard heating and sensing configurations. It may take a certain amount of time to achieve a change of, for example, 40° C. (e.g., 20° C. to 60° C.) for some power input.

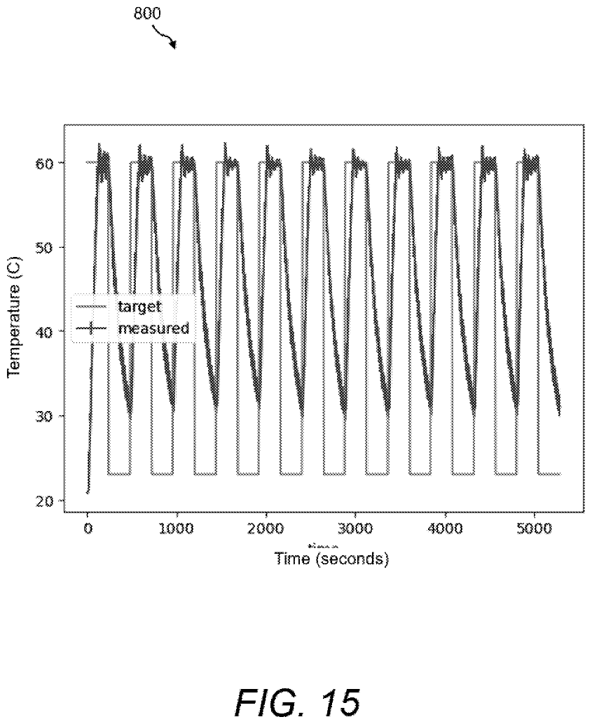

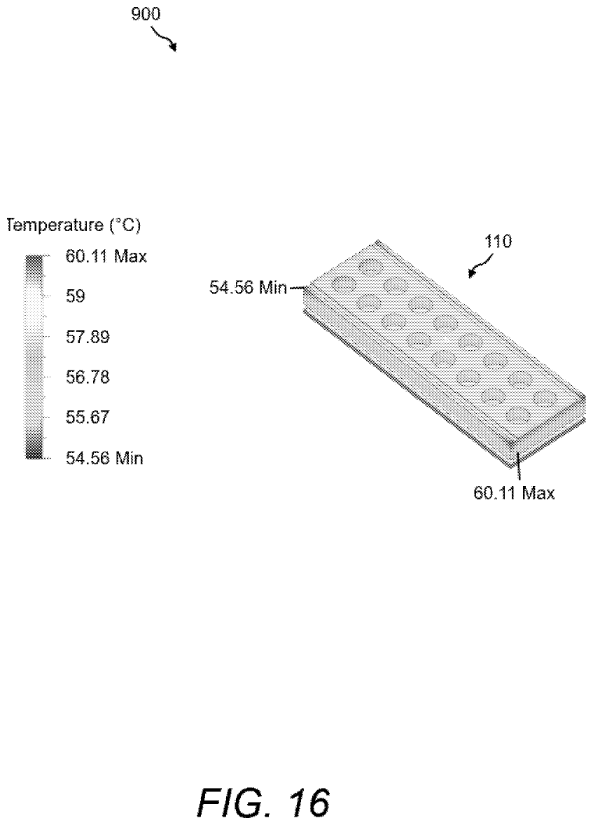

Referring now to FIG. 14B is a graph 750 of an example of the thermal response time. A curve 752 indicates an example of the time to achieve 60° C. per power unit. More specifically, this example estimates the time it takes to warm a Schott Borofloat 33 glass slide from 20° C. to 60° C. based on the power input. Further to the example, the fast temperature response time of microplate 110 including heater 150 allows rapid temperature cycling as shown, for example, in a graph 800 of FIG. 15. For example, graph 800 shows an example of an ITO resistive heating layer 154 heated and cooled repeatedly for eleven cycles and showing material robustness and reproducibility.

Referring now to FIG. 16 is a perspective view of an example of a thermal image 900 showing the measured temperature gradient (left) across a multi-well microplate (e.g., microplate 110, right) including an integrated resistive heater (e.g., heater 150).

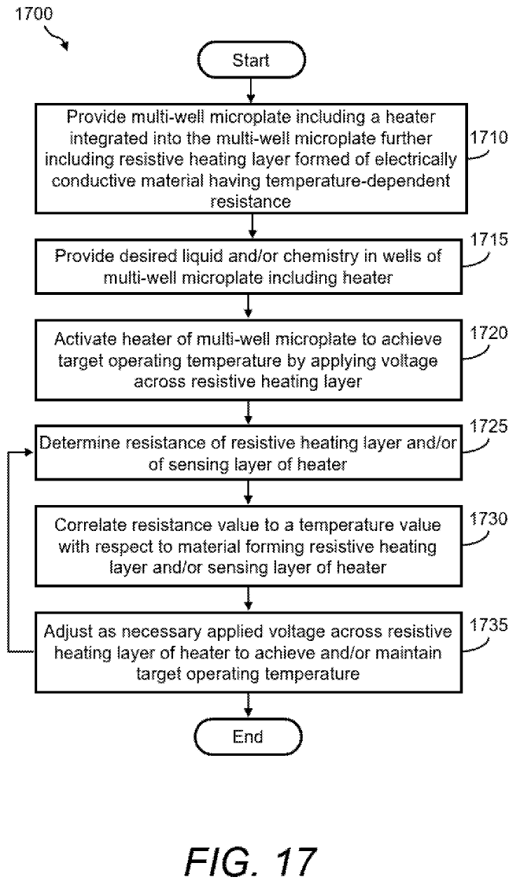

Referring now to FIG. 17 is a flow diagram of an example of a method 1700 of using a multi-well microplate (e.g., microplate 110) including an integrated resistive heater (e.g., heater 150), according to an embodiment of the inventive concepts. Method 1700 may include, but is not limited to, the following operations.

At operation 1710, a multi-well microplate including a heater integrated to the multi-well microplate is provided. Further, the heater may include a resistive heating layer formed of an electrically conductive material having a temperature-dependent resistance. For example, and referring now to FIG. 1 through FIG. 16, microplate 110 may be provided that includes well structure 112 and heater 150. Further, heater 150 may include resistive heating layer 154 on substrate 152. Resistive heating layer 154 may be formed of an electrically conductive material having a temperature-dependent resistance. For example, resistive heating layer 154 may be formed of ITO, ZTO, platinum, any conductive oxide material that has resistive properties, carbon nanotube-based films that have resistive properties, any kind of resistive thin film, and the like.

At operation 1715, an existing liquid and/or chemistry is provided in the wells of the multi-well microplate including the heater. For example, an existing liquid and/or chemistry is provided in wells 114 of well structure 112 of microplate 110 that further includes heater 150 thermally coupled to well structure 112.

At operation 1720, the heater of the multi-well microplate may be activated to achieve a target operating temperature by applying a voltage across its resistive heating layer. For example, using voltage source 124, heater 150 of microplate 110 is activated by applying a voltage across resistive heating layer 154 of heater 150. Examples of applying a voltage V across resistive heating layer 154 are shown in FIG. 7A, FIG. 8B, FIG. 9B, FIG. 10C, and FIG. 10D. In one example, in the case of an ITO resistive heating layer 154 and a target operating temperature of 20° C., the voltage V may be set to about 1 volt DC. In another example, in the case of an ITO resistive heating layer 154 and a target operating temperature of 95° C., the voltage V may be set initially to about 0 volts DC for the first measurement. Then the voltage V may be ramped up to a maximum of about 30 volts DC.

At operation 1725, the resistance of the resistive heating layer and/or of a sensing layer of the heater of the multi-well microplate may be determined. In one example and referring now to FIG. 8B and FIG. 9B, the current flow through resistive heating layer 154 of heater 150 of microplate 110 may be measured using, for example, a current meter function of thermal control unit 122 and/or voltage source 124. Then, using the measured current value and the voltage value applied in operation 1720, the resistance of resistive heating layer 154 of heater 150 of microplate 110 may be calculated according to Equation 1:

$$The resistance R may be calculated by R = V / I . \qquad [ Equation 1 ]$$

where V is voltage and I is current.

Continuing operation 1725, in another example and referring now to FIG. 10C, sensing layer 162 may be used in a constant voltage mode to determine the resistance of resistive heating layer 154 of heater 150. For example, apply a constant voltage V2 to sensing layer 162, then measure the current in sensing layer 162, and then calculate the resistance of sensing layer 162 according to Equation 1. Here, thermal control unit 122 and/or voltage source 124 may be used to provide the constant voltage and measure the current flow through sensing layer 162.

Continuing operation 1725, in another example and referring now to FIG. 10D, sensing layer 162 may be used in a constant current mode to determine the resistance of resistive heating layer 154 of heater 150. For example, apply a constant current through sensing layer 162, then measure the voltage across sensing layer 162, and then calculate the resistance of sensing layer 162 according to Equation 1. Here, thermal control unit 122 and/or voltage source 124 may be used to provide the constant current and measure the voltage across sensing layer 162.

At operation 1730, the resistance value is correlated to a temperature value with respect to material used to form the resistive heating layer and/or the sensing layer of the heater of the multi-well microplate. That is, the calculated resistance is correlated to a temperature based on the resistance properties of the material forming resistive heating layer 154 and/or sensing layer 162. For example, with respect to an ITO resistive heating layer 154 and/or an ITO sensing layer 162 of heater 150 of microplate 110, the calculated resistance value may be derived according to Equation 2 or Equation 3 below:

$$Then , the temperature may be derived by T = mR + b ; \qquad [ Equation 2 ]$$

where m is the slope of the line and b is intercept,

$$or , the temperature may be derived by T = m ( V / I ) + b \qquad [ Equation 3 ]$$

In another example, instead of calculating the temperature using Equations 2 and 3, a lookup table may be used. For example, the resistivity is defined as (rho=R*A/L), where rho=resistivity, R=resistance, A=cross section of ITO, and L=length of ITO. From this, if the ITO production quality is consistent, then a look up table based on an empirical measurement may be used to determine temperature.

At operation 1735, the applied voltage across the resistive heating layer of the heater may be adjusted to achieve and/or maintain the target operating temperature. For example, using voltage source 124, the voltage applied across resistive heating layer 154 of heater 150 of microplate 110 may be adjusted to achieve and/or maintain the target operating temperature (e.g., 20° C., 95° C.). The method 1700 may returns to operation 1725.

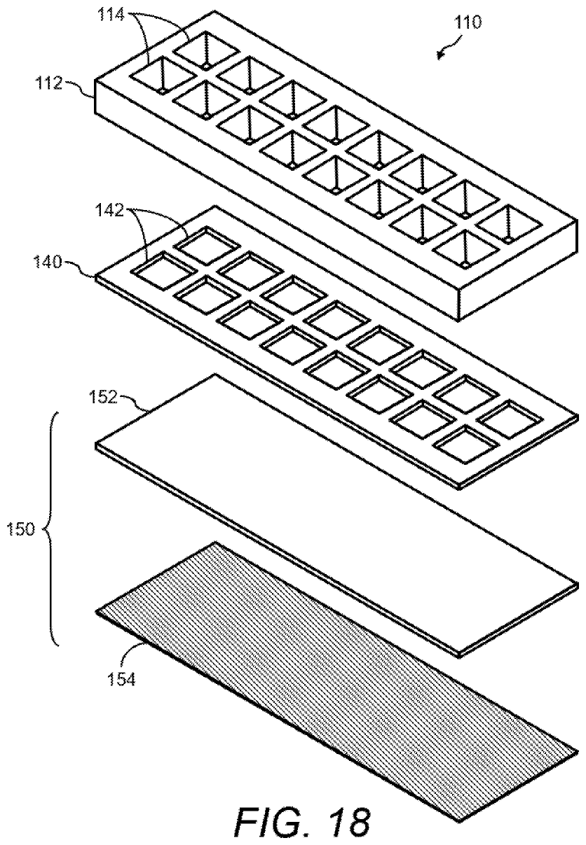

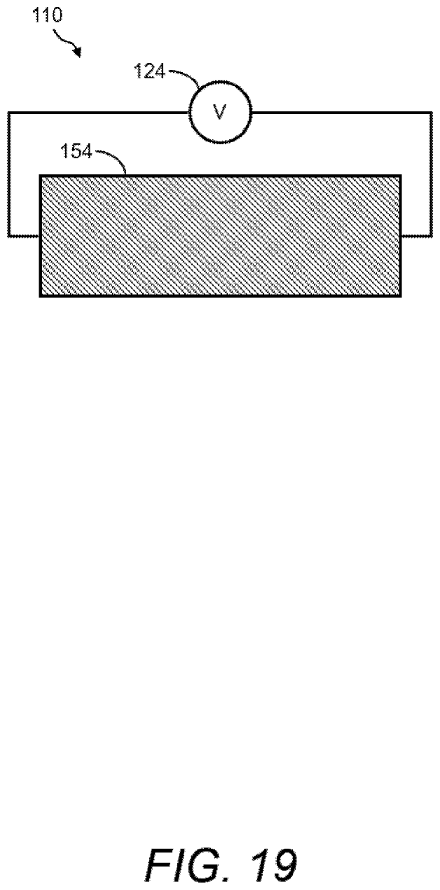

With respect to performing optical detection it may be beneficial to provide openings 156 in resistive heating layer 154. The pattern of openings 156 may substantially match the pattern of wells 114 of well structure 112 as shown above with reference to FIG. 2 through FIG. 10D. Openings 156 in resistive heating layer 154 provide unobstructed line of sight to wells 114 of well structure 112. However, certain materials, such as ITO and ZTO, are substantially transparent to light. Accordingly, in other embodiments, when resistive heating layer 154 of heater 150 of microplate 110 is formed of, for example, ITO or ZTO, then openings 156 may be omitted, as shown, for example, in FIG. 18 and FIG. 19.

Referring now to FIG. 18 is an exploded view of another example of microplate 110 including heater 150. In this example, resistive heating layer 154 of heater 150 is a continuous layer of material, such as ITO or ZTO, that is without openings 156. While, for example, ITO and ZTO may not be perfectly transparent, ITO and ZTO may have enough transparency to be used in heater 150 without openings 156 and still allow optical detection of well structure 112 to be performed effectively. Further to the example, FIG. 19 is a schematic diagram showing the voltage V applied to the continuous resistive heating layer 154 of the microplate 110 shown in FIG. 18. The voltage V induces current though the continuous resistive heating layer 154, which has a temperature-dependent resistance, and heat is generated by power dissipation.

Referring again to FIG. 1 through FIG. 19, fluidics system 100, microplate 110, and method 1700 provide microplate 110 that includes a multi-well well structure 112 and heater 150. Further, heater 150 may be a resistance-based heater that provides localized heating with respect to the multi-well well structure 112 and for achieving a temperature to perform chemical reactions efficiently.

In some embodiments, fluidics system 100, microplate 110, and method 1700 provide heater 150 including substrate 152 with resistive heating layer 154. In this example, the pattern of openings 156 in resistive heating layer 154 may substantially match the pattern of wells 114 in the multi-well well structure 112.

In some embodiments, fluidics system 100, microplate 110, and method 1700 provide heater 150 including substrate 152 with resistive heating layer 154. In this example, resistive heating layer 154 may be an electrically conductive and resistive material having temperature-dependent resistance, such as, but not limited to, ITO, ZTO, platinum, any conductive oxide material that has resistive properties, carbon nanotube-based films that have resistive properties, any kind of resistive thin film, and the like.

In some embodiments, fluidics system 100, microplate 110, and method 1700 provide heater 150 including substrate 152 with resistive heating layer 154. In this example, a voltage may be applied across resistive heating layer 154 and wherein the voltage induces current though resistive heating layer 154 and heat is generated by power dissipation.

In some embodiments, fluidics system 100, microplate 110, and method 1700 provide heater 150 including substrate 152 with resistive heating layer 154. In this example, heat is generated by power dissipation and wherein a feedback loop is provided for achieving and/or maintaining a target temperature and wherein the target temperature may be, for example, from about 15° C. to about 100° C.

In some embodiments, fluidics system 100, microplate 110, and method 1700 provide heater 150 including substrate 152 with resistive heating layer 154. In this example, heater 150 may further include passivation layer 160 deposited atop resistive heating layer 154 and then sensing layer 162 deposited atop passivation layer 160. Sensing layer 162 may be used as a feedback mechanism for controlling heater 150 of microplate 110.

In some embodiments, fluidics system 100, microplate 110, and method 1700 provide a consumable microplate 110 including heater 150. In this example, heater 150 may be used to provide a simplified fluidics system and/or instrument (e.g., less heating and cooling mechanisms) compared with existing fluidics systems and/or instruments.

Provided herein, in some embodiments, are well plates. The well plates may be integrated with resistive heating. In some embodiments, the well plate is a microwell plate. In some embodiments, the well plate has a multi-well structure. In some embodiments, the well plate is formed from one or more materials. In some embodiments, the well plate is formed from materials comprising polystyrene, polypropylene, polycarbonate, glass, quartz, or any combination thereof. In some embodiments, the well plate is formed from plastic materials. In some embodiments, the well plate is transparent. In some embodiments, the well plate is opaque.

The well plates may comprise a number of wells. In some embodiments, the well plate comprises 6 wells. In some embodiments, the well plate comprises 12 wells. In some embodiments, the well plate comprises 24 wells. In some embodiments, the well plate comprises 48 wells. In some embodiments, the well plate comprises 96 wells. In some embodiments, the well plate comprises 384 wells. In some embodiments, the well plate comprises 1536 wells. In some embodiments, the well plates may comprise more than or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 150, 200, 250, 300, 350, 400, 450, 500, 550, 600, 650, 700, 750 ,800 , 850, 900, 950, 1000, 2000, 3000, 4000, or 5000 wells. In some embodiments, the well plates may comprise less than or equal to 5000, 4000, 3000, 2000, 1000, 950, 900, 850, 800, 750, 700, 650, 600, 550, 500, 450, 400, 350, 300, 250, 200, 150, 100, 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, or 2 wells.

In some embodiments, each well in the well plates is configured to hold a volume of material. In some embodiments, each well is configured to hold about 50 to 2000 microliters (μL) of liquid. In some embodiments, each well is configured to hold more than or equal to 50 μL, 75 μL, 100 μL, 125 μL, 150 μL, 175 μL, 200 μL, 225 μL, 250 μL, 275 μL, 300 μL, 325 μL, 350 μL, 375 μL, 400 μL, 425 μL, 450 μL, 475 μL, 500 μL, 600 μL, 700 μL, 800 μL, 900 μL, 1000 μL, 1250 μL, 1500 μL, 1750 μL, or 2000 μL of liquid. In some embodiments, each well is configured to hole less than or equal to 2000 μL, 1750 μL, 1500 μL, 1250 μL, 1000 μL, 900 μL, 800 μL, 700 μL, 600 μL, 500 μL, 475 μL, 450 μL, 425 μL, 400 μL, 375 μL, 350 μL, 325 μL, 300 μL, 275 μL, 250 μL, 225 μL, 200 μL, 175 μL, 150 μL, 125 μL, 100 μL, 75 μL, or 50 μL of liquid.

Provided herein, in some embodiments, are heaters configured to heat the microplate of the present disclosure directly or indirectly. The heater may comprise a hot plate. The hot plate may comprise a ceramic hot plate, an aluminum hot plate, or a stainless-steel hot plate. The hot plate may comprise a base unit, a heating surface, a temperature controller, a magnetic stir bar, a stirring speed controller, a support rod, a clamp, a power cord, one or more fuses, one or more safety features, or any combination thereof. The hot plate may comprise a digital element. The heater may comprise a one or more reaction blocks. The reaction blocks may comprise metal block reaction blocks, aluminum block reaction blocks, dry block reaction blocks, well-plate reaction blocks, or any combination thereof. The reaction blocks may comprise a base plate, a cover, well inserts, rubber mats or PFA films, or any combination thereof. The reaction blocks may comprise 96 well inserts. In some embodiments, the reaction blocks may comprise about 1, 2, 3, 4, 5, 6, 7, 8, 9, 10, 12, 20, 24, 30, 40, 48, 50, 60, 70, 80, 90, 96, 100, 200, 300, 384, 400, 500, 600, 700, 800 900, 1000 or 1536 well inserts. The heater may comprise a vacuum oven. The heater may comprise a pass-through oven. The heater may be operatively connected to a voltage source.

The heaters disclosed herein may comprise a length. The length of the heater may be greater than or equal to 40 mm, 42 mm, 44 mm, 46 mm, 48 mm, 50 mm, 52 mm, 54 mm, 56 mm, 58 mm, 60 mm, 62 mm, 64 mm, 66 mm, 68 mm, 70 mm, 72 mm, 74 mm, 75 mm, 75.8 mm, 76 mm, 78 mm, 80 mm, 82 mm, 84 mm, 86 mm, 88 mm, 90 mm, 92 mm, 94 mm, 96 mm, 98 mm, 100 mm, 102 mm, 104 mm, 106 mm, 108 mm, 110 mm, 112 mm, 114 mm, 116 mm, 118 mm, 120 mm, 130 mm, 140 mm, 150 mm, 160 mm, 170 mm, 180 mm, 190 mm, 200 mm, 300 mm, 400 mm, 500 mm, 600 mm, or 700 mm. The length of the heater may be less than or equal to 700 mm, 600 mm, 500 mm, 400 mm, 300 mm, 200 mm, 190 mm, 180 mm, 170 mm, 160 mm, 150 mm, 140 mm, 130 mm, 120 mm, 118 mm, 116 mm, 114 mm, 112 mm, 110 mm, 108 mm, 106 mm, 104 mm, 102 mm, 100 mm, 98 mm, 96 mm, 94 mm, 92 mm, 90 mm, 88 mm, 86 mm, 84 mm, 82 mm, 80 mm, 78 mm, 76 mm, 75.8 mm, 75 mm, 74 mm, 72 mm, 70 mm, 68 mm, 66 mm, 64 mm, 62 mm, 60 mm, 58 mm, 56 mm, 54 mm, 52 mm, 50 mm, 48 mm, 46 mm, 44 mm, 42 mm, or 40 mm.

The heaters disclosed herein may comprise a width. The width may be greater than or equal to 8 mm, 10 mm, 12 mm, 14 mm, 16 mm, 18 mm, 20 mm, 22 mm, 24 mm, 25 mm, 26 mm, 28 mm, 30 mm, 32 mm, 34 mm, 36 mm, 38 mm, 40 mm, 42 mm, 44 mm, 46 mm, 48 mm, 50 mm, 52 mm, 54 mm, 56 mm, 58 mm, 60 mm, 62 mm, 64 mm, 66 mm, 68 mm, 70 mm, 72 mm, 74 mm, 76 mm, 78 mm, or 80 mm. The width may be less than or equal to 80 mm, 78 mm, 76 mm, 74 mm, 72 mm, 70 mm, 68 mm, 66 mm, 64 mm, 62 mm, 60 mm, 58 mm, 56 mm, 54 mm, 52 mm, 50 mm, 48 mm, 46 mm, 44 mm, 42 mm, 40 mm, 38 mm, 36 mm, 34 mm, 32 mm, 30 mm, 28 mm, 26 mm, 25 mm, 24 mm, 22 mm, 20 mm, 18 mm, 16 mm, 14 mm, 12 mm, 10 mm, or 8 mm.

Provided herein, in some embodiments, are substrates of the microplate of the present disclosure. In some embodiments, the substrate is disposed beneath the microplate. In some embodiments, the substrate is disposed above the microplate. In some embodiments, the substrate is embedded within the microplate. In some embodiments, the substrate is disposed beneath the well structure. In some embodiments, the substrate is disposed adjacent to the well structure. In some embodiments, the substrate is disposed above the well structure.

In some embodiments, the substrate is a patterned substrate. In some embodiments the patterned substrate comprises openings that substantially match the pattern of wells in the multi-well well structure of the microplate. In some embodiments, the patterned substrate comprises openings wherein each of the opening comprises a substantially circular shape. In some embodiments, the patterned substrate comprises openings wherein each of the opening comprises a substantially square shape. In some embodiments, the patterned substrate comprises opening configured a single-row pattern. In some embodiments, the patterned substrate comprises openings configured in a hexagonal pattern. In some embodiments, the patterned substrate comprises openings configured a funnel pattern. In some embodiments, the patterned substrate comprises openings configured in regular pattern wherein each of the openings may be equidistant from each other. For example, in some embodiments, each of the openings of the patterned substrate may be about 50 micrometers (μm) to about 15,000 μm from the other openings of the patterned substrate. In some embodiments, each of the openings of the patterned substrate may be about 50, 100, 200, 300, 400, 500, 600, 700, 800, 900, 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, 10,000, 10,500, 11,000, 11,500, 12,000, 12,500, 13,000, 13,500, 14,000, 14,500, 15,000, 15,500, 16,000, 16,500, 17,000, 17,500, or 18,000 μm from the other openings of the patterned substrate. In some embodiments, the patterned substrate comprises openings configured in an irregular pattern, wherein each of the openings may be a varying distance from the other openings.

In some embodiments, the substrate is a resistive heating layer. In some embodiments, the resistive heating layer may be formed of, for example, but not limited to, indium tin oxide (ITO), zinc tin oxide (ZTO), platinum, any conductive oxide material that has resistive properties, carbon nanotube-based films that have resistive properties, any kind of resistive thin film, and the like.

In some embodiments, the substrate comprises a thickness. In some embodiments, the substrate comprises a thickness of about 700 micrometers (μm) to about 1,100 μm. In some embodiments, the substrate comprises a thickness greater than or equal to 400, 450, 500, 550, 600, 650, 700, 750, 800, 850, 900, 950, 1,000, 1,050, 1,100, 1,150, 1,200, 1,250, 1,300, 1,350, 1,400, 1,450, 1,500, 1,550, or 1,600 μm. In some embodiments, the substrate comprises a thickness less than or equal to 1,600, 1,550, 1,500, 1,450, 1,400, 1,350, 1,300, 1,250, 1,200, 1,150, 1,100, 1,050, 1,000, 950, 900, 850, 800, 750, 700, 650, 600, 550, 500, 450, or 400 μm.

In some embodiments, the substrate is a resistive heating layer. In some embodiments, the substrate comprises a thickness of about 100 nanometers (nm) to about 200 nm. In some embodiments, the substrate comprises a thickness of greater than or equal to 50, 55, 60, 65, 70, 75, 80, 85, 90, 95, 100, 105, 110, 115, 120, 125, 130, 135, 140, 145, 150, 155, 160, 165 170, 175, 180, 185, 190, 195, 200, 205, 210, 215, 220, 225, 230, 235, 240, 245, or 250 nm. In some embodiments, the substrate comprises a thickness of less than or equal to 250, 245, 240, 235, 230, 225, 220, 215, 210, 205, 200, 195, 190, 185, 180, 175, 170, 165, 160, 155, 150, 145, 140, 135, 130, 125, 120, 115, 110, 105, 100, 95, 90, 85, 80, 75, 70, 65, 60, 55, or 50 nm.

In some embodiments, the substrate may comprise a length. The length may be in millimeters. In some embodiments, the length of the substrate may be from about 50 millimeters (mm) to about 250 mm. In some embodiments, the length of the substrate may be greater than or equal to 50 mm, 60 mm, 70 mm, 80 mm, 90 mm, 100 mm, 110 mm, 120 mm, 130 mm, 140 mm, 150 mm, 160 mm, 170 mm, 180 mm, 190 mm, 200 mm, 210 mm, 220 mm, 230 mm, 240 mm, or 250 mm. In some embodiments, the length of the substrate may be less than or equal to 250 mm, 240 mm, 230 mm, 220 mm, 210 mm, 200 mm, 190 mm, 180 mm, 170 mm, 160 mm, 150 mm, 140 mm, 130 mm, 120 mm, 110 mm, 100 mm, 90 mm, 80 mm, 70 mm, 60 mm, or 50 mm. In some embodiments, the substrate may comprise a width. The width may be in millimeters. In some embodiments, the width of the substrate may be from about 5 mm to about 80 mm. In some embodiments, the width of the substrate may be greater than or equal to 5 mm, 6 mm, 7 mm, 8 mm, 9 mm, 10 mm, 11 mm, 12 mm, 13 mm, 14 mm, 15 mm, 20 mm, 25 mm, 30 mm, 35 mm, 40 mm, 45 mm, 50 mm, 55 mm, 60 mm, 65 mm, 70 mm, 75 mm, or 80 mm. In some embodiments, the width of the substrate may be less than or equal to 80 mm, 75 mm, 70 mm, 65 mm, 60 mm, 55 mm, 50 mm, 45 mm, 40 mm, 35 mm, 30 mm, 25 mm, 20 mm, 15 mm, 14 mm, 13 mm, 12 mm, 11 mm, 10 mm, 9 mm, 8 mm, 7 mm, 6 mm, or 5 mm.

Provided herein, in some embodiments, are fluidic instruments. In some embodiments, the fluidic instruments comprise a mechanical stage 116, a liquid handling system 118, a thermal control unit 122, a detection system 120, or any combination thereof. In some embodiments, the fluidic instruments comprise a computer system 126. In some embodiments, the fluidic instruments comprise a microplate 110, a mechanical stage 116, or both. The microplate may comprise a well structure 112 and/or a heater 150. As shown in FIG. 1, mechanical stage 116 may be operatively coupled to microplate 110. In some embodiments, microplate 110 may be arranged atop mechanical stage 116. Still referring to FIG. 1, liquid handling system 122 may be operatively coupled to microplate 110. In some embodiments, liquid handling system 122 may be arranged above microplate 110. Still referring to FIG. 1, detection system 120 may be operatively coupled to mechanical stage 116, microplate 110, or both. In some embodiments, detection system 120 may be arranged below mechanical stage 116, microplate 110, or both. Still referring to FIG. 1, thermal control unit 122 may be operatively coupled to a voltage source. Still referring to FIG. 1, computer system 126 may be operatively coupled to mechanical stage 116, liquid handling system 122, thermal control unit 122, or any combination thereof.

Provided herein, in some embodiments, are mechanical stages of the fluidic instruments disclosed herein. In some embodiments, mechanical stage may be configured to move in one or more directions. In some embodiments, mechanical stage may be configured to move in an X direction, a Y direction, a Z direction, or any combination thereof. The mechanical stages disclosed herein may be operatively coupled to microplates disclosed herein. The mechanical stage may hold or support the microplate. The mechanical stage may be positioned below the microplate. For example, as shown in FIG. 1, mechanical stage 116 may be operatively coupled to microplate 118 such that microplate 118 is arranged atop mechanical stage 116. As such, in some embodiments, mechanical stage may be configured to move microplate in an X direction, a Y direction, a Z direction, or any combination.

The mechanical stage may be an X-Y translation mechanical stage. The mechanical stage may be an X-Y-Z translation mechanical stage. The mechanical stage may comprise a stage, a holder (e.g., a slide holder, a microplate holder, or the like), a stage opening, a stage lock control, one or more knobs, locator markings, or any combination thereof. The one or more knobs may be configured to move the mechanical stage in an X direction, a Y direction, a Z direction, or any combination thereof.

The mechanical stage may move automatically. The mechanical stage may move semi-automatically. The mechanical stage may move manually, for example, by a user. The mechanical stage may be in one direction, for example an X direction, a Y direction, or a Z direction. The mechanical stage may move in two directions, for example an X and Y direction, an X and Z direction, or a Y and Z direction.

Provided herein, in some embodiments, are liquid handling systems of the fluidic instruments disclosed herein. In some embodiments, the liquid handling system may be configured to extract one or more samples. The one or more samples may be liquid samples. The one or more samples may be extracted from the well structure of the microplate disclosed herein.

In some embodiments, the liquid handling system may include a fluid flow direction. For example, the liquid handling system may extract one or more samples from the well structure. In this example, a fluid flow direction from the well structure to the liquid handling system may be observed. As another example, the liquid handling system may withdraw one or more samples from the liquid handling system to the well structure. In this example, a fluid flow direction from the liquid handling system to the well structure may be observed.

In some embodiments, the liquid handling system is automatic. For example, the liquid handling system may comprise an automatic robotic-based pipette system. As another example, the liquid handling system may comprise an automated micropipette system, which may utilize a robotic arm to extract and transfer liquid samples from one container to another. The automatic liquid handling system may comprise a control interface, one or more pipettes, one or more pipetting heads, a liquid handling core, a working deck, mechanical motors, mechanical actuators, a waste disposal system, a pipetting robot system, or any combination thereof. The automatic liquid handling system may provide higher throughput without user intervention. The automatic liquid handling system may be configured to handle a large number of samples, for example, more than 100 samples.

In some embodiments, the liquid handling system is semi-automatic. The semi-automatic liquid handling system may comprise the elements of the automatic liquid handling system disclosed herein. The semi-automatic liquid handling system may be configured to handle a medium number of samples, for example 10 to 100 samples.

In some embodiments, the liquid handling system is manual. For example, the manual liquid handling system may comprise a user handling one or more manual pipettes. The manual liquid handling system may handle a smaller number of samples, for example 10 or less samples.

In some embodiments, the liquid handling system may comprise one or more pipettes. In some embodiments, the pipettes may comprise micropipettes. In some embodiments, a micropipette may measure between about 1 μL and 1,000 μL of liquid. In some embodiments, a pipette may measure between 1 mL to 50 mL. In some embodiments, the liquid handling system comprises more than or equal to 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 150, 200, 250, 300, 350, 400, 450, 500, 550, 600, 650, 700, 750, 800, 750, 900, 950, or 1,000 pipettes. In some embodiments, the liquid handling system comprises less than or equal to 1,000, 950, 900, 850, 800, 750, 700, 650, 600, 550, 500, 450, 400, 350, 300, 250, 200, 150, 100, 95, 90, 85, 80, 75, 70, 65, 60, 55, 50, 45, 40, 35, 30, 25, 20, 19, 18, 17, 16, 15, 14, 13, 12, 11, 10, 9, 8, 7, 6, 5, 4, 3, or 2 pipettes.

The pipettes may be configured to measure various volumes of liquids. In some embodiments, the pipettes may be configured to measure about 0.1 microliters (μL) to about 5,000 μL of liquid. In some embodiments, the pipettes may be configured to hold about 1, 2, 3, 4, 5, 10, 20, 30, 40, 50, 60, 70, 80, 90, 100, 200, 300, 400, 500, 600, 700, 800, 900, 1,000, 1,100, 1,200, 1,300, 1,400, 1,500, 1,600, 1,700, 1,800, 1,900, 2,000, 3,000, 4,000, or 5,000 μL of liquid. In some embodiments, the pipettes may be configured to measure about 1 mL to 100 mL. In some embodiments, the pipettes may be configured to hold about 1, 2, 3, 4, 5, 6, 7, 8, 9, 10, 15, 20, 25, 30, 35, 40, 45, 50, 55, 60, 65, 70, 75, 80, 85, 90, 95, or 100 mL.

The pipettes disclosed herein may comprise a grip, a plunger shaft, a plunger button, a tip ejector, a display, a tip, a tip ejector collar, a tip cone, a friction ring, a body, a connecting nut, a thumbwheel, a tip holder, or any combination thereof.

In some embodiments, the liquid handling system may comprise a fluidic flow system. In some embodiments, the fluidic flow system may comprise one or more pumps, valves, mixing manifolds, reagent reservoirs, waste reservoirs, or any combination thereof.

In some embodiments, the liquid handling system may comprise one or more buffers. The liquid handling system may comprise one or more solvents. The liquid handling system may comprise one or more pumps. The liquid handling system may comprise one or more chambers. The liquid handling system may comprise one or more connectors.

Provided herein, in some embodiments, are thermal control units. The thermal control units may be configured to regulate temperature precisely to optimize efficiency and performance of the fluidic instruments of the present disclosure. The thermal control unit may be operatively coupled to a voltage source, a computer system, or a combination thereof. In some embodiments, the fluidic instrument comprises the voltage source, and voltage from the voltage source may be used to control the operation of the heater disclosed herein. In some embodiments, the thermal control unit may control the voltage from the voltage source. As such, the thermal control unit may directly or indirect control operation of the heater of the microplate.

The thermal control unit may control a temperature of the heater. The thermal control unit may be precisely configured to control a temperature of the heater to optimize efficiency and performance of the fluidic instructions disclosed herein. In some embodiments, the thermal control unit may control a temperature to be about 15° C. to about 100° C. The thermal control unit may control a temperature to be about −20° C., −15° C., −10° C., −5° C., 0° C., 5° C., 10° C., 15° C., 20° C., 25° C., 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., or 120° C. The thermal control unit may control a temperature to heat a sample. The thermal control unit may control a temperature to cool a sample. In some embodiments, the thermal control unit may control a temperature to be about −50° C. to about 8° C. The thermal control unit may be configured to cool to a temperature of about −50° C., about −45° C., about −40° C., about −35° C., about −30° C., about −25° C., about −20° C., about −15° C., about −10° C., about −9° C., about −8° C., about −7° C., about −6° C., about −5° C., about −4° C., about −3° C., about −2° C., about −1° C., about 0° C., about 1° C., about 2° C., about 3° C., about 4° C., about 5° C., about 6° C., about 7° C., about 8° C., about 9° C., about 10° C., about 15° C., or about 20° C.

The thermal control unit may control a range of temperatures of the heater. The thermal control unit may be precisely configured to control a range of temperatures of the heater to optimize efficiency and performance of the fluidic instructions disclosed herein. In some embodiments, the thermal control unit may control a range of temperatures to be about 15° C. to about 15° C. The thermal control unit may control a range of temperatures to be about '20° C. to −about 10° C., about −10° C. to about 0° C., about 0° C. to about 10° C., about 10° C. to about 20° C., about 20° C. to about 30° C., about 30° C. to about 40° C., about 40° C. to about 50° C., about 50° C. to about 60° C., about 60° C. to about 70° C., about 70° C. to about 80° C., about 80° C. to about 90° C., about 90° C. to about 100° C., about 100° C. to about 110° C., or about 110° C. to about 120° C. In some embodiments, the thermal control unit may control a range of temperatures to be about −50° C. to-about −40° C., about −40° C. to about −30° C., about −30° C. to about −20° C., about −20° C. to about −10° C., about −10° C. to about −5° C., about −5° C. to about 0° C., about −3° C. to about 0° C., about 0° C. to about 3° C., about 0° C. to about 5° C., about 5° C. to about 10° C., or about 10° C. to about 20° C.

The thermal control unit may control a timing of a temperature of the heater. The thermal control unit may be precisely configured to control a timing of a temperature of the heater to optimize efficiency and performance of the fluidic instructions disclosed herein. In some embodiments, the thermal control may be configured to control the heater to be a particular temperature for any number of seconds, minutes, or hours. In some embodiments, the thermal control unit may be configured to control the heater to be a particular range of temperatures for any number of seconds, minutes, or hours.

In some embodiments, the thermal control unit is operatively connected to a computer system. In some embodiments, the thermal control unit is connected to the computer system via wires. In some embodiments, the thermal control unit is wirelessly connected to the computer system. The thermal control unit may be connected to the computer system as described herein.

The thermal control unit may be operatively coupled to a computer system as disclosed herein. The computer system may be configured to control the thermal control unit. In some embodiments, the computer system may be configured to control a temperature, a range of temperatures, a timing of temperatures, or a combination thereof, of the thermal control unit. In this example, the temperature, ranges of temperatures, or timing of temperatures, or a combination thereof, of the thermal control unit may control a temperature, a range of temperatures, or a timing of temperatures, or a combination thereof, of the microplate. As such, a thermal control unit as described herein can provide for more control over temperature requirements for biological assays, thereby providing for a more robust and reproducible assay.

In some embodiments, the thermal control unit may comprise one or more temperature control components. Non-limiting examples of temperature control components include resistive heating elements, infrared light sources, heating or cooling devices, heat sinks, thermocouples, thermistors, or a combination thereof. In some embodiments, the thermal control unit may provide changes in temperature over specified time intervals. In some embodiments, the thermal control unit may provide an increase in temperature. In some embodiments, the thermal control unit may provide a decrease in temperature. In some embodiments, the thermal control unit may provide for cycling of temperatures. In some embodiments, the thermal control unit may provide a constant temperature.

Provided herein, in some embodiments, are detection systems of the fluidic instruments disclosed herein. In some embodiments, the detection system is or comprises an optical detection system. In some embodiments, the optical system comprises a light source and an optical measurement device. In some embodiments, the detection systems may comprise one or more light sources, one or more optical components, one or more filters, one or one or more imaging sensors for imaging and detection, or a combination thereof.

In some embodiments, the one or more light sources may comprise light from a bulb. The light source may be at a wavelength in the visible range (e.g., 400-800 nanometers (nm)), such as, but not limited to, a white light-emitting diode (LED), a halogen bulb/lamp, an arc lamp, a deuterium lamp, a xenon lamp, an incandescent lamp, lasers, and the like. In some embodiments, the light source comprises a wavelength of greater than or equal to 200 nm, 250 nm, 300 nm, 350 nm, 400 nm, 500 nm, 550 nm, 600 nm, 650 nm, 700 nm, 750 nm, 800 nm, 850 nm, 900 nm, 1000 nm, 1050 nm, or 1100 nm. In some embodiments, the light source comprises a wavelength of less than or equal to 1100 nm, 1050 nm, 1000 nm, 950 nm, 900 nm, 850 nm, 800 nm, 750 nm, 700 nm, 650 nm, 600 nm, 550 nm, 500 nm, 450 nm, 400 nm, 350 nm, 300 nm, 250 nm, or 200 nm.

In some embodiments, the one or more optical components may comprise one or more lenses, one or more mirrors, digital mirror devices, prisms, optical filters, colored glass filters, narrowband interference filters, broadband interference filters, dichroic reflectors, diffraction gratings, apertures, optical fibers, optical waveguides, or any combination thereof. In some embodiments, the one or more optical components may comprise about 1, 2, 3, 4, 5, 6, 7, 8, 9, 10, 11, 12, 13, 14, 15, 16, 17, 18, 19, 20, 21, 22, 23, 24, or 25 optical components. In some embodiments, the one or more lenses may comprise about 1, 2, 3, 4, 5, 6, 7, 8, 9, 10, 11, 12, 13, 14, 15, 16, 17, 18, 19, 20, 21, 22, 23, 24, or 25 lenses. In some embodiments, the one or more mirrors may comprise about 1, 2, 3, 4, 5, 6, 7, 8, 9, 10, 11, 12, 13, 14, 15, 16, 17, 18, 19, 20, 21, 22, 23, 24, or 25 mirrors. In some embodiments, the digital mirror devices may comprise about 1, 2, 3, 4, 5, 6, 7, 8, 9, 10, 11, 12, 13, 14, 15, 16, 17, 18, 19, 20, 21, 22, 23, 24, or 25 digital mirror devices. In some embodiments, the filters may comprise about 1, 2, 3, 4, 5, 6, 7, 8, 9, 10, 11, 12, 13, 14, 15, 16, 17, 18, 19, 20, 21, 22, 23, 24, or 25 filters. In some embodiments, the filters may comprise about 1, 2, 3, 4, 5, 6, 7, 8, 9, 10, 11, 12, 13, 14, 15, 16, 17, 18, 19, 20, 21, 22, 23, 24, or 25 types of filters. The one or more optical components may be used to obtain readings, for example, light intensity readings. The one or more optical components may comprise an optical measurement device. The optical measurement device may be, for example, a charge coupled device, a photodetector, a spectrometer, a photodiode array, or any combinations thereof. The optical measurement device may comprise optical wavelength meters, microscopes, interferometers, measuring instruments, illumination, high measurement performance, or any combination thereof.

In some embodiments, the photodetector may comprise avalanche photodiodes (APDs), PIN diodes, photodiodes, phototransistors, Schottky photodiodes, MSM photodetectors, photoconductors, photomultiplier tubes, or any combination thereof.

In some embodiments, the microscope may comprise a compound microscope, a stereo microscope, a fluorescence microscope, an inverted microscope, a phase contrast microscope, a polarizing microscope, a digital microscope, a light microscope, a confocal microscope, a scanning probe microscope, a transmission electron microscope, a metallurgical microscope, a confocal laser microscope, an acoustic microscope, an atomic force microscope, a darkfield microscope, an x-ray microscope, or any combination thereof.

In some embodiments, a spectrometer is used in the detection system. The spectrometer may comprise various types of spectroscopies. In some embodiments, the spectroscopy may comprise Raman spectroscopy, UV spectroscopy, atomic absorption spectroscopy, infrared (IR) spectroscopy, x-ray spectroscopy, absorption spectroscopy, fluorescence spectroscopy, magnetic resonance spectroscopy, optical nuclear magnetic resonance (NMR) spectroscopy, spark spectroscopy, IR and NIR spectroscopy, or any combination thereof.

In some embodiments, the one or more imaging sensors may comprise a charge-coupled device (CCD) sensor or camera, a complementary metal-oxide-semiconductor (CMOS) imaging sensor or camera, a negative-channel metal-oxide semiconductor (NMOS) imaging sensor or camera, or a combination thereof. In some embodiments, the one or more imaging sensors comprises more than or equal to about 1, 2, 3, 4, 5, 6, 7, 8, 9, 10, 11, 12, 13, 14, 15, 16, 17, 18, 19, 20, 21, 22, 23, 24, or 25 imaging sensors.

The detection systems disclosed herein may be configured to detect a readout indicative of a presence of an analyte of interest.

In some embodiments, a fluorescent moiety may be used in the detection systems disclosed herein. The fluorescent moiety may emit in the red, far-red, near-red, yellow, green, or blue wavelengths. In some embodiments, the fluorescent moiety comprises one or more of 6-FAM (6-carboxyfluorescein), JOE (6-carboxy-4′,5′-dichloro-2′,7′-dimethoxyfluorescein), TAMRA (6-carboxytetramethylrhodamine), 5-Cy5 (5-carboxyrhodamine), 5-Cy5.5 (5-carboxylic acid succinimidyl ester), 5-Cy7 (5-carboxyrhodamine), (hexachlorofluorescein), Alexa Fluor 488 (AF488), Alexa Fluor 514 (AF514), Texas Red, Cyanine 3, Cyanine 5, Pacific Blue, Tetramethyl rhodamine, Oxazole Yellow, Atto647N, and Rhodamine 6G (R6G).

In some embodiments, about 1, 2, 3, 4, 5, 6, 7, 8, 9, 10, 11, 12, 13, 14, 15, 16, 17, 18, 19, 20, 21, 22, 23, 24, or 25 fluorescent moieties are used in the detection systems disclosed herein.

In some embodiments, the fluorescent moiety may comprise a fluorophore. The fluorophore may emit a color in the visible light spectrum. In some embodiments, the fluorophore may emit in a wavelength in the range between 400 nm and 900 nm. The fluorophore may emit in a wavelength between 400 nm and 475 nm, 475 nm and 490 nm, 490 nm and 530 nm, 530 nm and 575 nm, 575 nm and 600 nm, 600 nm and 700 nm, or 700 nm and 800 nm. In some embodiments, the fluorophore may emit a wavelength of 400 nm or more, 425 nm or more, 450 nm or more, 475 nm or more, 500 nm or more, 525 nm or more, 550 nm or more, 575 nm or more, 600 nm or more, 625 nm or more, 650 nm or more, 675 nm or more, 700 nm or more, 725 nm or more, 750 nm or more, 775 nm or more, 800 nm or more, 825 nm or more, 850 nm or more, 875 nm or more, or 900 nm or more. The fluorophore may emit a wavelength of 900 nm or less, 875 nm or less, 850 nm or less, 825 nm or less, 800 nm or less, 775 nm or less, 750 nm or less, 725 nm or less, 700 nm or less, 675 nm or less, 650 nm or less, 625 nm or less, 600 nm or less, 575 nm or less, 550 nm or less, 525 nm or less, 500 nm or less, 475 nm or less, 450 nm or less, 425 nm or less, or 400 nm or less.

The wavelength of light that the fluorophore emits may correspond to a color on the visible spectrum. Examples of colors include, but are not limited to, green, blue, red, yellow, orange, pink, purple, or a combination thereof. For example, in some embodiments, a fluorophore emitting light in a wavelength between 400 nm and 475 nm may produce a purple color. In some embodiments, a fluorophore emitting in a wavelength between 420 nm and 530 nm may produce a blue color. In some embodiments, a fluorophore emitting in a wavelength between 490 nm and 575 nm may produce a green color. In some embodiments, a fluorophore emitting in a wavelength between 530 nm and 600 nm may produce a yellow color. In some embodiments, a fluorophore emitting in a wavelength between 575 nm and 750 nm may produce an orange color. In some embodiments, fluorophore emitting in a wavelength between 600 nm and 800 nm may emit a red color.

In some embodiments, chemiluminescence is used in the detection systems disclosed herein. The chemiluminescence may comprise use of one or more analytical devices, one or more chemical sensors, bioluminescence, or any combination thereof.

The detection systems may detection assays, for example, encoded assays. Examples of encoded assays can be found in WO2023/096674, which is incorporated herein by reference in its entirety.

Provided herein, in some embodiments are samples analyzed using the fluidic systems disclosed herein. In some embodiments, one or more samples may be analyzed using the fluidics systems disclosed herein. In some embodiments, more than or equal to 1, 2, 3, 4, 5, 6, 7, 8, 9, 10, 11, 12, 13, 14, 15, 16, 17, 18, 19, 20, 30, 40, 50, 60, 70, 80, 90, 100, 125, 150, 175, 200, 225, or 250 samples may be analyzed using the fluidics systems disclosed herein. In some embodiments, less than or equal to 250, 225, 200, 175, 150, 125, 100, 90, 80, 70, 60, 50, 40, 30, 20, 19, 18, 17, 16, 15, 14, 13, 12, 11, 10, 9, 8, 7, 6, 5, 4, 3, or 2 samples may be analyzed using the fluidics systems disclosed herein.

In some embodiments, the samples may comprise a buccal swab sample, a tissue sample such as a biopsy sample, a saliva sample, a blood sample, a plasma sample, a serum sample, a urine sample, a sputum sample, or the like. The samples may comprise biological samples. For example, the samples may comprise whole blood samples, lymphatic fluid samples, serum samples, plasma samples, sweat samples, tear samples, saliva samples, sputum samples, cerebrospinal fluid samples, amniotic fluid samples, seminal fluid samples, vaginal excretion samples, serous fluid samples, synovial fluid samples, pericardial fluid samples, peritoneal fluid samples, pleural fluid samples, transudates samples, exudates samples, cystic fluid samples, bile samples, urine samples, gastric fluid samples, intestinal fluid samples, fecal samples, liquid samples comprising cells (single or multiple cells), liquid samples comprising organelles, fluidized tissue samples, fluidized organism samples, liquid samples comprising multi-celled organisms, biological swab samples, biological wash samples, or the like.

In some embodiments, the samples may comprise nucleic acids. For example, deoxyribonucleic acid (DNA) and/or ribonucleic acid (RNA). In some embodiments, the samples may comprise proteins.

In some embodiments, the samples may be from any organism (e.g., prokaryotes, eukaryotes, plants, animals, humans, or the like) or other sample (e.g., environmental or forensic samples). In some embodiments, a sample preparation process may be used to produce a sequencing-ready sample from a raw sample or partially processed sample. In some embodiments, one or more samples may be combined for sample preparation and/or sequencing and may be distinguished post-sequencing using sample-specific DNA barcodes linked to sample fragments.

Provided herein are methods of manufacturing or using the fluidic instrument or system disclosed herein. In some embodiments, the methods of manufacturing the fluidic instrument of the present disclosure may comprise providing a well structure comprising at least one well configured to support the sample. The methods of manufacture may comprise providing a heater integrated into the microplate. The heater integrated into the microplate may be configured to provide localized resistive heat to the well structure by heating both the well structure and the sample. The methods of manufacture may comprise providing a fluidics instrument comprising a surrounding environment of the microplate. The methods of manufacture may comprise providing a mechanical stage supporting the microplate. The mechanical stage is operatively coupled to the microplate. The methods of manufacture may comprise providing a liquid handling system arranged to deposit and remove liquid from the microplate. The liquid handing system may be positioned above the microplate. The methods of manufacture may comprise providing a detection system configured to detect materials from the wells of the well structure. The methods of manufacture may comprise providing a thermal control unit. The methods of manufacture may comprise providing a computing system configured to manage operations of the mechanical stage, the liquid handling system, and the detection system.

Provided herein are methods of using the fluidics instruments and systems of the present disclosure to apply localized resistive heat to the microplate of the instant disclosure. In some embodiments, the localized resistive heat applies heat to the well structure and the sample without substantially heating the surrounding environment of the microplate.

Provided herein are method for heating a sample. The method may comprise placing a sample in a microplate. The sample may be any of the samples as disclosed herein. The method may comprise use of a number of samples, for example, about 1, 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100, 200, 300, 400, 500, 600, 700, 800, 900, or 1000 samples. The microplate may comprise a well structure comprising at least one well configured to support the sample. The microplate may comprise integrating a heater into the microplate, wherein the heater is configured to provide localized resistive heat to the well structure of the microplate by heating both the well structure and the sample.

In some embodiments, the method may comprise applying a voltage. The voltage may be applied to the well structure. The voltage may be measured in volts. The applying the voltage may cause the well structure to generate a localized resistive heat. The voltage may be applied via a voltage source. The voltage source may comprise one or more batteries, one or more generators, one or more power adapters, one or more solar panels, one or more electrical outlets, one or more USB ports on e.g., a computer, one or more power suppliers, and the like. In some embodiments, the voltage source may comprise about 1, 2, 3, 4, 5, 6, 7, 8, 9, 10, 11, 12, 13, 14, 15, 16, 17, 18, 19, 20, 21, 22, 23, 24, or 25 batteries. In some embodiments, the voltage source may comprise about 1, 2, 3, 4, 5, 6, 7, 8, 9, 10, 11, 12, 13, 14, 15, 16, 17, 18, 19, 20, 21, 22, 23, 24, or 25 generators. In some embodiments, the voltage source may comprise about 1, 2, 3, 4, 5, 6, 7, 8, 9, 10, 11, 12, 13, 14, 15, 16, 17, 18, 19, 20, 21, 22, 23, 24, or 25 power adapters. In some embodiments, the voltage source may comprise about 1, 2, 3, 4, 5, 6, 7, 8, 9, 10, 11, 12, 13, 14, 15, 16, 17, 18, 19, 20, 21, 22, 23, 24, or 25 solar panels. In some embodiments, the voltage source may comprise about 1, 2, 3, 4, 5, 6, 7, 8, 9, 10, 11, 12, 13, 14, 15, 16, 17, 18, 19, 20, 21, 22, 23, 24, or 25 electrical outlets. In some embodiments, the voltage source may comprise about 1, 2, 3, 4, 5, 6, 7, 8, 9, 10, 11, 12, 13, 14, 15, 16, 17, 18, 19, 20, 21, 22, 23, 24, or 25 power suppliers.

In some embodiments, the method may comprise locally heating the sample using the localized resistive heat. The localized resistive heat may be dependent on an applied voltage and resistive properties of a resistive heating layer of the well structure.

In some embodiments, the method comprises heating the sample. The heating may comprise locally heating of the sample (e.g., not heating a surrounding environment of the microplate). The heating may cause a chemical reaction to occur in the sample. The heating may cause a biological process to occur in the sample. The sample may be heated to a temperature within a range from about 15 degrees Celsius (° C.) to about 100° C. The sample may be heated to a temperature of about −20° C., about −15° C., about −10° C., about −5° C., about 0° C., about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., or about 120° C.

In some embodiments, the method comprises cooling the sample. The cooling may comprise locally cooling of the sample (e.g., not cooling a surrounding environment of the microplate). The cooling may cause a chemical reaction to stop or slow down in the sample. The cooling may cause a biological process to stop or slow down in the sample. The sample may be cooled to a temperature within a range from about −50° C. to about 8° C. The sample may be cooled to a temperature of about −50° C., about −45° C., about −40° C., about −35° C., about −30° C., about −25° C., about −20° C., about −15° C., about −10° C., about −9° C., about −8° C., about −7° C., about −6° C., about −5° C., about −4° C., about −3° C., about −2° C., about −1° C., about 0° C., about 1° C., about 2° C., about 3° C., about 4° C., about 5° C., about 6° C., about 7° C., about 8° C., about 9° C., about 10° C., about 15° C., or about 20° C.

The surrounding environment of the microplate may comprise a mechanical stage supporting the microplate. The mechanical stage may be operatively coupled to the microplate. The surrounding environment of the microplate may comprise a liquid handling system. The liquid handling system may be arranged to deposit and remove liquid from the microplate. The liquid handling system may be positioned above the microplate. The surrounding environment of the microplate may comprise a detection system configured to detect materials from the wells in the well structure. The surrounding environment of the microplate may comprise a computing system configured to manage the operations of the mechanical stage, the liquid handling system, and the detection system.

In some embodiments, the heater may comprise a substrate and a resistive heating layer patterned thereon. The pattern of the resistive heating layer may comprise openings that substantially match the configuration of the at least one well. The resistive heating layer may comprise a material comprising indium tin oxide (ITO), zinc tin oxide (ZTO), platinum, oxides, carbon nanotubes, and combinations thereof.

In some embodiments, the substrate may be optically transparent. The substrate may have a thickness from about 700 micrometers (μm) to about 1100 μm. In some embodiments, the substrate comprises a thickness greater than or equal to 400, 450, 500, 550, 600, 650, 700, 750, 800, 850, 900, 950, 1,000, 1,050, 1,100, 1,150, 1,200, 1,250, 1,300, 1,350, 1,400, 1,450, 1,500, 1,550, or 1,600 μm. In some embodiments, the substrate comprises a thickness less than or equal to 1,600, 1,550, 1,500, 1,450, 1,400, 1,350, 1,300, 1,250, 1,200, 1,150, 1,100, 1,050, 1,000, 950, 900, 850, 800, 750, 700, 650, 600, 550, 500, 450, or 400 μm.

The resistive heating layer may comprise a thickness from about 100 nanometers (nm) to about 200 nm. In some embodiments, the substrate comprises a thickness of greater than or equal to 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, or 250 nm. In some embodiments, the substrate comprises a thickness of less than or equal to 250, 245, 240, 235, 230, 225, 220, 215, 210, 205, 200, 195, 190, 185, 180, 175, 170, 165, 160, 155, 150, 145, 140, 135, 130, 125, 120, 115, 110, 105, 100, 95, 90, 85, 80, 75, 70, 65, 60, 55, or 50 nm.

In some embodiments, the heater may comprise electrical contacts adjacent to and electrically connected with the resistive heating layer. The heater may generate heat when a voltage is applied across the resistive heating layer. In some embodiments, a temperature of the resistive heating layer may be dependent on the applied voltage and resistive properties of the resistive heating layer. In some embodiments, a temperature of the well structure may be dependent on the temperature of the resistive heating layer.

The methods disclosed herein may be applied to detection assays, for example, encoded assays. Examples of encoded assays can be found in WO2023/096674, which is incorporated herein by reference in its entirety.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The term “substantially” is used herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the inventive concepts will be apparent to the skilled person without departing from the scope and spirit of the inventive concepts. Although the inventive concepts have been disclosed in connection with specific aspects or embodiments, it should be understood that the inventive concepts as claimed should not be unduly limited to such specific aspects or embodiments.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller, reflecting tolerances, conversion factors, rounding off, measurement error and the like, and other existing factors depending on the properties sought to be obtained by the subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

The terms “subject” or “individual” are often used interchangeably herein. A “subject” can be a biological entity containing expressed genetic materials. The biological entity can be a plant, animal, or microorganism, including, for example, bacteria, viruses, fungi, and protozoa. The subject can be tissues, cells and their progeny of a biological entity obtained in vivo or cultured in vitro. The subject can be a mammal. The mammal can be a human. The subject may be diagnosed or suspected of being at high risk for a disease. In some cases, the subject is not necessarily diagnosed or suspected of being at high risk for the disease.

While preferred embodiments of the present inventive concepts have been shown and described herein, it will be obvious to those skilled in the art that such embodiments are provided by way of example only. Numerous variations, changes, and substitutions will now occur to those skilled in the art without departing from the inventive concepts. It should be understood that various alternatives to the embodiments of the inventive concepts described herein may be employed in practicing the inventive concepts. It is intended that the following claims define the scope of the inventive concepts and that methods and structures within the scope of these claims and their equivalents be covered thereby.

What is claimed is:

1. A method for heating a sample comprising:
(a) placing a sample in a microplate, wherein the microplate comprises a well structure comprising at least one well configured to support the sample,
(b) integrating a heater into the microplate, wherein the heater is configured to provide localized resistive heat to the well structure of the microplate by heating both the well structure and the sample,
(c) applying a voltage to the well structure, causing the well structure to generate a localized resistive heat, and
(d) locally heating the sample using the localized resistive heat, wherein the localized resistive heat is dependent on an applied voltage and resistive properties of a resistive heating layer of the well structure, and wherein the localized resistive heat does not substantially provide heat to a surrounding environment of the well structure.

2. The method of claim 1, wherein the heater comprises an optically clear substrate and a resistive heating layer patterned thereon.

3. The method of claim 2, wherein the optically clear substrate has a thickness from about 700 micrometers to about 1100 micrometers and the resistive heating layer comprises a thickness from about 100 nanometers to about 200 nanometers.

4. The method of claim 2, wherein the resistive heating layer comprises one or more of indium tin oxide, zinc tin oxide, platinum, and carbon nanotubes.

5. The method of claim 1, wherein the well structure comprises a material of one or more of polycarbonate, copolymer, and cyclic olefin copolymer.

6. The method of claim 1, wherein locally heating the sample causes a chemical or biological process to occur.

7. The method of claim 1, wherein the surrounding environment of the microplate comprises:
(i) a mechanical stage supporting the microplate, wherein the mechanical stage is operatively coupled to the microplate,
(ii) a liquid handling system arranged to deposit and remove liquid from the microplate, wherein the liquid handling system is positioned above the microplate,
(iii) a detection system configured to detect materials from the wells in the well structure,
(iv) a thermal control unit operatively coupled to a voltage source, and
(v) a computing system configured to manage the operations of the mechanical stage, the liquid handling system, and the detection system.

8. A microplate used for heating a sample, the microplate comprising:
(a) a well structure comprising a plurality of wells configured to support a plurality of samples, wherein the well structure comprises a material comprising polycarbonate, copolymer, cyclic olefin copolymer or a combination thereof,
(b) a heater integrated into the microplate, wherein the heater integrated into the microplate is configured to provide localized resistive heat to the well structure by heating both the well structure and the plurality of samples, wherein the localized resistive heat does not substantially heat a surrounding environment of the microplate.

9. The microplate of claim 8, wherein the heater comprises a substrate and a resistive heating layer patterned thereon.

10. The microplate of claim 9, wherein the substrate is optically transparent.

11. The microplate of claim 9, wherein the substrate comprises a thickness from about 700 micrometers and to about 1100 micrometers.

12. The microplate of claim 9, wherein the resistive heating layer comprises a thickness of about 100 nanometers to about 200 nanometers.

13. The microplate of claim 9, wherein the resistive heating layer comprises one or more of indium tin oxide, zinc tine oxide, platinum, oxides, and carbon nanotubes.

14. The microplate of claim 9, wherein the heater further comprises electrical contacts adjacent to and electrically connected with the resistive heating layer.

15. The microplate of claim 9, wherein the heater is configured to generate heat when a voltage is applied across the resistive heating layer.

16. The microplate of claim 15, wherein a temperature of the resistive heating layer is dependent on the applied voltage and resistive properties of the resistive heating layer.

17. The microplate of claim 16, wherein a temperature of the well structure is dependent on the temperature of the resistive heating layer.

18. A fluidics system for processing a sample, comprising a microplate for heating a sample, the microplate comprising:
(a) a well structure comprising at least one well configured to support the sample,
(b) a heater integrated into the microplate, wherein the heater comprises an optically transparent substrate and a resistive heating layer patterned thereon, and wherein the heater is configured to provide localized resistive heat to the well structure by locally heating both the well structure and the sample, and
(c) a fluidics instrument comprising the microplate and a surrounding environment of the microplate, wherein the surrounding environment of the microplate comprises one or more of
(i) a mechanical stage supporting the microplate, wherein the mechanical stage is operatively coupled to the microplate,
(ii) a liquid handling system arranged to deposit and remove liquid from the microplate, wherein the liquid handling system is positioned above the microplate,
(iii) a detection system configured to detect materials from the wells of the well structure,
(iv) a thermal control unit operatively coupled to a volage source, or
(v) a computing system configured to manage the operations of the mechanical stage, the liquid handling system, and the detection system, wherein the localized resistive heat does not substantially heat the surrounding environment of the microplate.

19. The fluidics system of claim 18, wherein the substrate comprises a thickness from about 700 micrometers to about 1100 micrometers and the resistive heating layer comprises a thickness from about 100 nanometers to about 200 nanometers.

20. The fluidics system of claim 18, wherein the resistive heating layer comprises a material comprising one or more of indium tin oxide, zinc tin oxide, platinum, oxides, and carbon nanotubes, or any combination thereof.
